(19) United States
(12) Patent Application Publication
(10) Pub. No.: US 2026/0189328 A1
(43) Pub. Date: Jul. 2, 2026

(54) COMMUNICATION METHOD AND COMMUNICATION APPARATUS

(71) Applicant: HUAWEI TECHNOLOGIES CO., LTD., Shenzhen (CN)

(72) Inventors: Ting Wang, Shanghai (CN); Hao Tang, Shanghai (CN); Na Gao, Shanghai (CN); Dongdong Wei, Shenzhen (CN); Lei Dong, Shanghai (CN); Jianglei Ma, Ottawa (CA)

(73) Assignee: HUAWEI TECHNOLOGIES CO., LTD., Shenzhen (CN)

(21) Appl. No.: 19/531,298

(22) Filed: Feb. 5, 2026

Related U.S. Application Data
(63) Continuation of application No. PCT/CN2023/111439, filed on Aug. 7, 2023.

(51) Int. Cl. H04L 5/00; H04W 72/044

(52) U.S. Cl. CPC H04L 5/0005; H04W 72/046

(57) ABSTRACT

This application provides a communication method and a communication apparatus, to improve communication reliability; and can be applied to a communication system. The method includes: A first apparatus receives first indication information from a second apparatus, where the first indication information indicates a first resource and a second resource, the first resource is used by a third apparatus to send first information to the first apparatus, and the second resource is used by the second apparatus to send the first information to the first apparatus. The first apparatus receives the first information sent by the third apparatus on the first resource, and receives the first information sent by the second apparatus on the second resource.

### CROSS-REFERENCE TO RELATED APPLICATIONS

This application is a continuation of International Application No. PCT/CN2023/111439, filed on Aug. 7, 2023, the disclosure of which is hereby incorporated by reference in its entirety.

### TECHNICAL FIELD

This application relates to the field of communication technologies, and in particular, to a communication method and a communication apparatus.

### BACKGROUND

In ultra-reliable low-latency communication (URLLC), there is a scenario in which different terminal apparatuses communicate with each other. The different terminal apparatuses may communicate with each other by using the following procedure: A network apparatus sends downlink control information (DCI) to a terminal apparatus #1, to indicate a resource used by the terminal apparatus #1 to send information to a terminal apparatus #2. The terminal apparatus #1 sends the information to the terminal apparatus #2 based on the resource indicated by the downlink control information.

In the foregoing solution, data of the terminal apparatus #1 is transmitted to the terminal apparatus #2 via the terminal apparatus #1, and reliability is low. Therefore, how to improve communication reliability is an urgent problem to be resolved.

### SUMMARY

Embodiments of this application provide a communication method and a communication apparatus, to improve communication reliability.

To achieve the foregoing objective, the following technical solutions are used in this application.

According to a first aspect, a communication method is provided. The communication method includes: A first apparatus receives first indication information from a second apparatus, where the first indication information indicates a first resource and a second resource, the first resource is used by a third apparatus to send first information to the first apparatus, and the second resource is used by the second apparatus to send the first information to the first apparatus. The first apparatus receives the first information sent by the third apparatus on the first resource, and receives the first information sent by the second apparatus on the second resource.

Based on the method provided in the first aspect, the second apparatus may indicate, by using the first indication information, resources used by different apparatuses to send the first information, e.g., resources for sending the first information on different links, for example, the first resource and the second resource. The first apparatus may receive, based on the resources indicated by the second apparatus, the first information transmitted through the different links, thereby receiving information on a plurality of links, so that transmissions of the same piece of information on the plurality of links are implemented, to improve communication reliability.

In an embodiment, the first resource may include a first time-frequency resource, and the second resource may include a second time-frequency resource. That is, time-frequency resources may be indicated for the different communication links.

In an embodiment, the first time-frequency resource may be the same as the second time-frequency resource, to reduce time-frequency resource overheads, and improve time-frequency resource utilization. In addition, communication latency can be reduced. Alternatively, the first time-frequency resource may be different from the second time-frequency resource, to avoid communication interference between the different apparatuses, and reduce a requirement on demodulation performance of a receiver. This is applicable to devices in more forms. In addition, decoupling of time-frequency resources of the different apparatuses can also improve communication flexibility.

In an embodiment, the first resource may further include a first space domain resource, and the second resource may further include a second space domain resource. That is, space domain resources may be indicated for the different communication links, to perform beam alignment, thereby improving the communication reliability.

In this case, the first indication information may include first quasi-colocation relationship information and second quasi-colocation information, where the first quasi-colocation information indicates the first space domain resource, and the second quasi-colocation information indicates the second space domain resource.

In an embodiment, the first indication information further indicates a first communication link between the third apparatus and the first apparatus and a second communication link between the second apparatus and the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus. In this way, an apparatus that receives the first indication information can determine, based on the first indication information, whether to receive information on the first resource and the second resource, thereby avoiding receiving unnecessary information, to reduce overheads.

In an embodiment, that the first apparatus receives the first information sent by the third apparatus on the first resource, and receives the first information sent by the second apparatus on the second resource may include: The first apparatus receives the first information sent by the third apparatus on the first resource, and successfully performs decoding; and/or the first apparatus receives the first information sent by the second apparatus on the second resource, and successfully performs decoding; or the first apparatus receives the first information sent by the third apparatus on the first resource, the first apparatus receives the first information sent by the second apparatus on the second resource, and successfully performs combined decoding. In other words, decoding, for example, separate decoding or combined decoding, needs to be performed on the same piece of information received on the plurality of communication links. In comparison with a solution of communication through a single communication link, even if decoding of the information on a communication link is unsuccessful, it is still possible that the information on another communication link can be successfully decoded or the combined decoding is successful, thereby improving the communication reliability, reducing a quantity of retransmissions, and improving communication efficiency.

In an embodiment, the method provided in the first aspect may further include: The first apparatus receives second indication information from the second apparatus, where the second indication information indicates a third resource, and the third resource is used by the third apparatus to send the first information to the first apparatus. The first apparatus receives the first information sent by the third apparatus on the third resource. In this way, before the first information sent by the third apparatus on the first resource is received, and the first information sent by the second apparatus on the second resource is received, the first information sent by the third apparatus on the third resource can be received, so that the first apparatus can combine information in processes of an initial transmission and a retransmission to perform combined decoding, so that the communication reliability can be further improved.

In an embodiment, the second indication information further indicates a fourth resource, and the fourth resource is used by the third apparatus to send the first information to the second apparatus.

Further, the third resource may include a third time-frequency resource, and the fourth resource may include a fourth time-frequency resource.

The third time-frequency resource may be the same as the fourth time-frequency resource, to reduce the time-frequency resource overheads, and improve the time-frequency resource utilization. In addition, the communication latency can be reduced. Alternatively, the third time-frequency resource may be different from the fourth time-frequency resource, to avoid communication interference between different apparatuses, and reduce the requirement on the demodulation performance of the receiver. This is applicable to the devices in the more forms. In addition, decoupling of time-frequency resources of the different apparatuses can also improve the communication flexibility.

Further, the third resource may further include a third space domain resource, and the fourth resource may further include a fourth space domain resource. That is, space domain resources may be indicated for different communication links, to perform beam alignment, thereby further improving the communication reliability.

In this case, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link between the third apparatus and the first apparatus and a fourth communication link between the third apparatus and the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be the identification information of the third apparatus, and the identification information of the receiving end apparatus on the third communication link may be the identification information of the first apparatus. The identification information of the transmitting end apparatus on the fourth communication link may be the identification information of the third apparatus, and the identification information of the receiving end apparatus on the fourth communication link may be the identification information of the second apparatus.

In an embodiment, the first indication information may further include a process number for a transmission of the first information. The second indication information may further include a process number for the transmission of the first information. In this way, the first apparatus can determine, based on the process numbers, whether information on different communication links is a same piece of information.

It may be understood that the process number for the transmission of the first information in the first indication information may be the same as the process number for the transmission of the first information in the second indication information.

In an embodiment, that the first apparatus receives the first information sent by the third apparatus on the first resource, and receives the first information sent by the second apparatus on the second resource; and that the first apparatus receives the first information sent by the third apparatus on the third resource may include: The first apparatus receives the first information sent by the third apparatus on the first resource, and successfully performs decoding; and/or the first apparatus receives the first information sent by the second apparatus on the second resource, and successfully performs decoding; or the first apparatus receives the first information sent by the third apparatus on the first resource, the first apparatus receives the first information sent by the second apparatus on the second resource, or the first apparatus receives the first information sent by the third apparatus on the third resource; and combined decoding on at least two pieces of the first information is successfully performed. In other words, decoding, for example, separate decoding or combined decoding, needs to be performed on the same piece of information received on a plurality of communication links in the initial transmission and the retransmission. In comparison with a solution of communication through a single communication link, even if decoding of the information on a communication link is unsuccessful, it is still possible that the information on another communication link can be successfully decoded or the combined decoding is successful, thereby improving the communication reliability, reducing a quantity of retransmissions, and improving communication efficiency.

In an embodiment, the method provided in the first aspect may further include: The first apparatus receives third indication information from the second apparatus, where the third indication information indicates one or more of the following: a size of the first indication information, a quantity of links corresponding to the first indication information, or a quantity of time-frequency resources indicated by the first indication information. In this way, the first apparatus can receive the first indication information in a targeted manner based on the third indication information, so that the communication efficiency can be improved.

In an embodiment, the method provided in the first aspect may further include: The first apparatus sends first feedback information to the second apparatus, where the first feedback information indicates whether the first apparatus successfully receives the first information.

In an embodiment, the method provided in the first aspect may further include: The first apparatus receives fourth indication information from the second apparatus, where the fourth indication information indicates one or more of the following: a size of the second indication information, a quantity of links corresponding to the second indication information, or a quantity of time-frequency resources indicated by the second indication information. In this way, the first apparatus can receive the second indication information in the targeted manner based on the fourth indication information, so that the communication efficiency can be improved.

In an embodiment, the first apparatus is a terminal apparatus, the second apparatus is a network apparatus, and the third apparatus is a terminal apparatus.

According to a second aspect, a communication method is provided. The communication method includes: A third apparatus receives second indication information from a second apparatus, where the second indication information indicates a third resource and a fourth resource, the third resource is used by the third apparatus to send first information to a first apparatus, and the fourth resource is used by the third apparatus to send the first information to the second apparatus. The third apparatus sends the first information to the first apparatus on the third resource, and sends the first information to the second apparatus on the fourth resource.

Based on the method provided in the second aspect, the second apparatus may indicate, by using the second indication information, resources used by one apparatus to send the first information to a plurality of apparatuses, e.g., resources for sending the first information on different links, for example, the third resource for sending the information to the first apparatus and the fourth resource for sending the information to the second apparatus. The third apparatus may send the first information to the different links based on the resources indicated by the second apparatus, to send information on a plurality of links, so that transmissions of the same piece of information on the plurality of links can be implemented, to improve communication reliability. In addition, the information is sent on the plurality of links, and the information may be transmitted in parallel on the different links, so that communication latency can be reduced.

In an embodiment, the third resource may include a third time-frequency resource, and the fourth resource may include a fourth time-frequency resource.

In an embodiment, the third time-frequency resource may be the same as the fourth time-frequency resource, to reduce time-frequency resource overheads, and improve time-frequency resource utilization. In addition, the communication latency can be reduced. Alternatively, the third time-frequency resource may be different from the fourth time-frequency resource, to avoid communication interference between different apparatuses, and reduce a requirement on demodulation performance of a receiver. This is applicable to devices in more forms. In addition, decoupling of time-frequency resources of the different apparatuses can also improve communication flexibility.

In an embodiment, the third resource may further include a third space domain resource, and the fourth resource may further include a fourth space domain resource. That is, space domain resources may be indicated for different communication links, to perform beam alignment, thereby improving the communication reliability.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the method provided in the second aspect may further include: The third apparatus receives first indication information from the second apparatus, where the first indication information indicates a first resource, and the first resource is used by the third apparatus to send the first information to the first apparatus. The third apparatus sends the first information to the first apparatus on the first resource.

In an embodiment, the first indication information may further indicate a second resource, and the second resource is used by the second apparatus to send the first information to the first apparatus.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be the identification information of the third apparatus, and the identification information of the receiving end apparatus on the first communication link may be the identification information of the first apparatus. The identification information of the transmitting end apparatus on the second communication link may be the identification information of the second apparatus, and the identification information of the receiving end apparatus on the second communication link may be the identification information of the first apparatus.

In an embodiment, the first indication information may include a process number for a transmission of the first information. The second indication information may include a process number for the transmission of the first information. In this way, the first apparatus can determine, based on the process numbers, whether information on different communication links is a same piece of information.

It may be understood that the process number for the transmission of the first information in the first indication information may be the same as the process number for the transmission of the first information in the second indication information. In this way, the process numbers can indicate that the information on the different communication links is the same piece of information, to reduce complexity of the first apparatus, thereby improving communication efficiency.

In an embodiment, the method provided in the second aspect may further include: The third apparatus receives third indication information from the second apparatus, where the third indication information indicates one or more of the following: a size of the first indication information, a quantity of links corresponding to the first indication information, or a quantity of time-frequency resources indicated by the first indication information. In this way, the third apparatus can receive the first indication information in a targeted manner based on the third indication information, so that the communication efficiency can be improved.

In an embodiment, the method provided in the second aspect may further include: The third apparatus receives fourth indication information from the second apparatus, where the fourth indication information indicates one or more of the following: a size of the second indication information, a quantity of links corresponding to the second indication information, or a quantity of time-frequency resources indicated by the second indication information. In this way, the third apparatus can receive the fourth indication information in the targeted manner based on the third indication information, so that the communication efficiency can be improved.

In an embodiment, the first apparatus is a terminal apparatus, the second apparatus is a network apparatus, and the third apparatus is a terminal apparatus.

According to a third aspect, a communication method is provided. The communication method includes: A second apparatus generates first indication information, where the first indication information indicates a first resource and a second resource, the first resource is used by a third apparatus to send first information to a first apparatus, and the second resource is used by the second apparatus to send the first information to the first apparatus. The second apparatus sends the first indication information.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may further include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. For example, the identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus.

In an embodiment, the method provided in the third aspect may further include: The second apparatus sends the first information to the first apparatus on the second resource.

In an embodiment, the method provided in the third aspect may further include: The second apparatus sends second indication information, where the second indication information indicates a fourth resource, and the fourth resource is used by the third apparatus to send the first information to the second apparatus. The second apparatus receives the first information sent by the third apparatus on the fourth resource.

In an embodiment, the second indication information may further indicate a third resource, and the third resource is used by the third apparatus to send the first information to the first apparatus.

Further, the third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource further includes a third space domain resource, and the fourth resource further includes a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the method provided in the third aspect may further include: The second apparatus sends third indication information, where the third indication information indicates one or more of the following: a size of the first indication information, a quantity of links corresponding to the first indication information, or a quantity of time-frequency resources indicated by the first indication information.

In an embodiment, the method provided in the third aspect may further include: The second apparatus receives first feedback information from the first apparatus, where the first feedback information indicates whether the first apparatus successfully receives the first information.

In an embodiment, the method provided in the third aspect may further include: The second apparatus sends fourth indication information, where the fourth indication information indicates one or more of the following: a size of the second indication information, a quantity of links corresponding to the second indication information, or a quantity of time-frequency resources indicated by the second indication information.

In an embodiment, the first apparatus is a terminal apparatus, the second apparatus is a network apparatus, and the third apparatus is a terminal apparatus.

In addition, for technical effects of the third aspect, refer to the technical effects of the communication method according to the first aspect. Details are not described herein again.

According to a fourth aspect, a communication method is provided. The communication method includes: A second apparatus generates second indication information, where the second indication information indicates a third resource and a fourth resource, the third resource is used by a third apparatus to send first information to a first apparatus, and the fourth resource is used by the third apparatus to send the first information to the second apparatus. The second apparatus sends the second indication information.

In an embodiment, the third resource may include a third time-frequency resource, and the fourth resource may include a fourth time-frequency resource.

In an embodiment, the third time-frequency resource may be the same as the fourth time-frequency resource, or the third time-frequency resource may be different from the fourth time-frequency resource.

In an embodiment, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the method provided in the fourth aspect may further include: The second apparatus receives the first information sent by the third apparatus on the fourth resource.

In an embodiment, the method provided in the fourth aspect may further include: The second apparatus sends first indication information, where the first indication information indicates a first resource and a second resource, the first resource is used by the third apparatus to send the first information to the first apparatus, and the second resource is used by the second apparatus to send the first information to the first apparatus. The second apparatus sends the first information to the first apparatus on the second resource.

In an embodiment, the first resource may include a first time-frequency resource, and the second resource may include a second time-frequency resource. In this way, time-frequency resources may be indicated for different communication links.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be the identification information of the third apparatus, and the identification information of the receiving end apparatus on the first communication link may be the identification information of the first apparatus. The identification information of the transmitting end apparatus on the second communication link may be the identification information of the second apparatus, and the identification information of the receiving end apparatus on the second communication link may be the identification information of the first apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the method provided in the fourth aspect may further include: The second apparatus sends third indication information, where the third indication information indicates one or more of the following: a size of the first indication information, a quantity of links corresponding to the first indication information, or a quantity of time-frequency resources indicated by the first indication information.

In an embodiment, the method provided in the fourth aspect may further include: The second apparatus receives first feedback information from the first apparatus, where the first feedback information indicates whether the first apparatus successfully receives the first information.

In an embodiment, the method provided in the fourth aspect may further include: The second apparatus sends fourth indication information, where the fourth indication information indicates one or more of the following: a size of the second indication information, a quantity of links corresponding to the second indication information, or a quantity of time-frequency resources indicated by the second indication information.

In an embodiment, the first apparatus is a terminal apparatus, the second apparatus is a network apparatus, and the third apparatus is a terminal apparatus.

In addition, for technical effects of the fourth aspect, refer to the technical effects of the communication method according to the second aspect. Details are not described herein again.

According to a fifth aspect, a communication method is provided. The communication method includes: A first apparatus receives first indication information from a second apparatus, where the first indication information indicates a first resource and a second resource, the first resource is used by a third apparatus to send first information to the first apparatus, and the second resource is used by the second apparatus to send the first information to the first apparatus. The third apparatus receives the first indication information from the second apparatus. The third apparatus sends the first information on the first resource. The first apparatus receives the first information sent by the third apparatus on the first resource, and receives the first information sent by the second apparatus on the second resource.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

In this case, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link between the third apparatus and the first apparatus and a second communication link between the second apparatus and the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus.

In an embodiment, that the first apparatus receives the first information sent by the third apparatus on the first resource, and receives the first information sent by the second apparatus on the second resource may include: The first apparatus receives the first information sent by the third apparatus on the first resource, and successfully performs decoding; and/or the first apparatus receives the first information sent by the second apparatus on the second resource, and successfully performs decoding; or the first apparatus receives the first information sent by the third apparatus on the first resource, the first apparatus receives the first information sent by the second apparatus on the second resource, and combined decoding is successfully performed.

In an embodiment, the method provided in the fifth aspect may further include: The first apparatus receives second indication information from the second apparatus, where the second indication information indicates a third resource, and the third resource is used by the third apparatus to send the first information to the first apparatus. The third apparatus receives the second indication information from the second apparatus. The third apparatus sends the first information on the third resource. The first apparatus receives the first information sent by the third apparatus on the third resource.

In an embodiment, the second indication information further indicates a third communication link between the third apparatus and the first apparatus and a fourth communication link between the third apparatus and the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be the identification information of the third apparatus, and the identification information of the receiving end apparatus on the third communication link may be the identification information of the first apparatus. The identification information of the transmitting end apparatus on the fourth communication link may be the identification information of the third apparatus, and the identification information of the receiving end apparatus on the fourth communication link may be the identification information of the second apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, that the first apparatus receives the first information sent by the third apparatus on the first resource, and receives the first information sent by the second apparatus on the second resource; and that the first apparatus receives the first information sent by the third apparatus on the third resource may include: The first apparatus receives the first information sent by the third apparatus on the first resource, and successfully performs decoding; and/or the first apparatus receives the first information sent by the second apparatus on the second resource, and successfully performs decoding; or the first apparatus receives the first information sent by the third apparatus on the first resource, the first apparatus receives the first information sent by the second apparatus on the second resource, or the first apparatus receives the first information sent by the third apparatus on the third resource; and combined decoding on at least two pieces of the first information is successfully performed.

In an embodiment, the second indication information may further indicate a fourth resource, and the fourth resource is used by the third apparatus to send the first information to the second apparatus; and the method provided in the fifth aspect may further include: The third apparatus sends the first information on the fourth resource.

Further, the third resource may include a third time-frequency resource, and the fourth resource may include a fourth time-frequency resource.

Further, the third time-frequency resource may be the same as the fourth time-frequency resource, or the third time-frequency resource may be different from the fourth time-frequency resource.

Further, the third resource may further include a third space domain resource, and the fourth resource may further include a fourth space domain resource.

In this case, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the method provided in the fifth aspect may further include: The first apparatus receives third indication information. The third apparatus receives the third indication information, where the third indication information indicates one or more of the following: a size of the first indication information, a quantity of links corresponding to the first indication information, or a quantity of time-frequency resources indicated by the first indication information.

In an embodiment, the method provided in the fifth aspect may further include: The first apparatus sends first feedback information, where the first feedback information indicates whether the first apparatus successfully receives the first information.

In an embodiment, the method provided in the fifth aspect may further include: The first apparatus receives fourth indication information. The third apparatus receives the fourth indication information, where the fourth indication information indicates one or more of the following: a size of the second indication information, a quantity of links corresponding to the second indication information, or a quantity of time-frequency resources indicated by the second indication information.

In an embodiment, the first apparatus is a terminal apparatus, the second apparatus is a network apparatus, and the third apparatus is a terminal apparatus.

In addition, for technical effects of the fifth aspect, refer to the technical effects of the communication method according to either the first aspect or the second aspect. Details are not described herein again.

According to a sixth aspect, a communication method is provided. The communication method includes: A first apparatus receives first indication information, where the first indication information indicates a first resource on a first communication link and a second resource on a second communication link; and link types of the first communication link and the second communication link are different, or types of transmitting end apparatuses on the first communication link and the second communication link are different. The first apparatus receives first information on the first resource on the first communication link, and receives the first information on the second resource on the second communication link.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information may include at least one of the following: identification information of the transmitting end apparatus on the first communication link, identification information of a receiving end apparatus on the first communication link, identification information of the transmitting end apparatus on the second communication link, and identification information of a receiving end apparatus on the second communication link.

In an embodiment, that the first apparatus receives the first information on the first resource on the first communication link, and receives the first information on the second resource on the second communication link may include: The first apparatus receives the first information on the first resource on the first communication link, and successfully performs decoding; and/or the first apparatus receives the first information on the second resource on the second communication link, and successfully performs decoding; or the first apparatus receives the first information on the first resource on the first communication link, the first apparatus receives the first information on the second resource on the second communication link, and combined decoding is successfully performed.

In an embodiment, the method provided in the sixth aspect may further include: The first apparatus receives second indication information, where the second indication information indicates a third resource on a third communication link. The first apparatus receives the first information on the third resource on the third communication link.

In an embodiment, the second indication information further indicates a fourth resource on a fourth communication link; and link types of the third communication link and the fourth communication link are different, or types of transmitting end apparatuses on the third communication link and the fourth communication link are different.

Further, the third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information may include at least one of the following: identification information of the transmitting end apparatus on the third communication link, identification information of a receiving end apparatus on the third communication link, identification information of the transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, that the first apparatus receives the first information on the first resource on the first communication link, and receives the first information on the second resource on the second communication link; and that the first apparatus receives the first information on the third resource on the third communication link may include: The first apparatus receives the first information on the first resource on the first communication link, and successfully performs decoding; the first apparatus receives the first information on the second resource on the second communication link, and successfully performs decoding; and/or the first apparatus receives the first information on the third resource on the third communication link, and successfully performs decoding; or the first apparatus receives the first information on the first resource on the first communication link, the first apparatus receives the first information on the second resource on the second communication link, and the first apparatus receives the first information on the third resource on the third communication link; and combined decoding is successfully performed.

In an embodiment, the method provided in the sixth aspect may further include: The first apparatus receives third indication information, where the third indication information indicates one or more of the following: a size of the first indication information, a quantity of links corresponding to the first indication information, or a quantity of time-frequency resources indicated by the first indication information.

In an embodiment, the method provided in the sixth aspect may further include: The first apparatus sends first feedback information, where the first feedback information indicates whether the first apparatus successfully receives the first information.

In an embodiment, the method provided in the sixth aspect may further include: The first apparatus receives fourth indication information, where the fourth indication information indicates one or more of the following: a size of the second indication information, a quantity of links corresponding to the second indication information, or a quantity of time-frequency resources indicated by the second indication information.

In an embodiment, the first apparatus may be a terminal apparatus.

In addition, for technical effects of the sixth aspect, refer to the technical effects of the communication method according to the first aspect. Details are not described herein again.

According to a seventh aspect, a communication method is provided. The communication method includes: A third apparatus receives second indication information, where the second indication information indicates a third resource on a third communication link and a fourth resource on a fourth communication link; and link types of the third communication link and the fourth communication link are different, or types of receiving end apparatuses on the third communication link and the fourth communication link are different. The third apparatus sends first information on the third resource on the third communication link, and sends the first information on the fourth resource on the fourth communication link.

In an embodiment, the third resource may include a third time-frequency resource, and the fourth resource may include a fourth time-frequency resource.

In an embodiment, the third time-frequency resource may be the same as the fourth time-frequency resource, or the third time-frequency resource may be different from the fourth time-frequency resource.

In an embodiment, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information may include at least one of the following: identification information of a transmitting end apparatus on the third communication link, identification information of the receiving end apparatus on the third communication link, identification information of a transmitting end apparatus on the fourth communication link, and identification information of the receiving end apparatus on the fourth communication link.

In an embodiment, the method provided in the seventh aspect may further include: The third apparatus receives first indication information, where the first indication information indicates a first resource on a first communication link. The third apparatus sends the first information on the first resource on the first communication link.

In an embodiment, the first indication information may further indicate a second resource on a second communication link; and link types of the first communication link and the second communication link are different, or types of transmitting end apparatuses on the first communication link and the second communication link are different.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information may include at least one of the following: identification information of the transmitting end apparatus on the first communication link, identification information of a receiving end apparatus on the first communication link, identification information of the transmitting end apparatus on the second communication link, and identification information of a receiving end apparatus on the second communication link.

In an embodiment, the first indication information may include a process number for a transmission of the first information. The second indication information may include a process number for the transmission of the first information.

It may be understood that the process number for the transmission of the first information in the first indication information may be the same as the process number for the transmission of the first information in the second indication information.

In an embodiment, the method provided in the seventh aspect may further include: The third apparatus receives third indication information, where the third indication information indicates one or more of the following: a size of the first indication information, a quantity of links corresponding to the first indication information, or a quantity of time-frequency resources indicated by the first indication information.

In an embodiment, the method provided in the seventh aspect may further include: The third apparatus receives fourth indication information, where the fourth indication information indicates one or more of the following: a size of the second indication information, a quantity of links corresponding to the second indication information, or a quantity of time-frequency resources indicated by the second indication information.

In an embodiment, the third apparatus may be a terminal apparatus.

In addition, for technical effects of the seventh aspect, refer to the technical effects of the communication method according to the second aspect. Details are not described herein again.

According to an eighth aspect, a communication method is provided. The communication method includes: A second apparatus generates first indication information, where the first indication information indicates a first resource on a first communication link and a second resource on a second communication link; link types of the first communication link and the second communication link are different, or types of transmitting end apparatuses on the first communication link and the second communication link are different; and a receiving end apparatus on the first communication link is the same as a receiving end apparatus on the second communication link. The second apparatus sends the first indication information.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information may include at least one of the following: identification information of the transmitting end apparatus on the first communication link, identification information of the receiving end apparatus on the first communication link, identification information of the transmitting end apparatus on the second communication link, and identification information of the receiving end apparatus on the second communication link.

In an embodiment, the method provided in the eighth aspect may further include: The second apparatus sends first information on the second resource on the second communication link.

In an embodiment, the method provided in the eighth aspect may further include: The second apparatus sends second indication information, where the second indication information further indicates a fourth resource on a fourth communication link. The second apparatus receives the first information on the fourth resource on the fourth communication link.

In an embodiment, the second indication information further indicates a third resource on a third communication link.

Further, the third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource further includes a third space domain resource, and the fourth resource further includes a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the method provided in the eighth aspect may further include: The second apparatus sends third indication information, where the third indication information indicates one or more of the following: a size of the first indication information, a quantity of links corresponding to the first indication information, or a quantity of time-frequency resources indicated by the first indication information.

In an embodiment, the method provided in the eighth aspect may further include: The second apparatus receives first feedback information, where the first feedback information indicates whether a first apparatus successfully receives the first information.

In an embodiment, the method provided in the eighth aspect may further include: The second apparatus sends fourth indication information, where the fourth indication information indicates one or more of the following: a size of the second indication information, a quantity of links corresponding to the second indication information, or a quantity of time-frequency resources indicated by the second indication information.

In an embodiment, the second apparatus is a network apparatus.

In addition, for technical effects of the eighth aspect, refer to the technical effects of the communication method according to the first aspect. Details are not described herein again.

According to a ninth aspect, a communication method is provided. The communication method includes: A second apparatus generates second indication information, where the second indication information indicates a third resource on a third communication link and a fourth resource on a fourth communication link; link types of the third communication link and the fourth communication link are different, or types of receiving end apparatuses on the third communication link and the fourth communication link are different; and a transmitting end apparatus on a third communication link is the same as a transmitting end apparatus on a fourth communication link. The second apparatus sends the second indication information.

In an embodiment, the third resource may include a third time-frequency resource, and the fourth resource may include a fourth time-frequency resource.

In an embodiment, the third time-frequency resource may be the same as the fourth time-frequency resource, or the third time-frequency resource may be different from the fourth time-frequency resource.

In an embodiment, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information may include at least one of the following: identification information of a transmitting end apparatus on the third communication link, identification information of the receiving end apparatus on the third communication link, identification information of a transmitting end apparatus on the fourth communication link, and identification information of the receiving end apparatus on the fourth communication link.

In an embodiment, the method provided in the ninth aspect may further include: The second apparatus sends first indication information, where the first indication information indicates a first resource on the first communication link and a second resource on the second communication link; and link types of the first communication link and the second communication link are different, or types of the transmitting end apparatuses on the first communication link and the second communication link are different. The second apparatus sends first information on the second resource on the second communication link.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information may include at least one of the following: identification information of the transmitting end apparatus on the first communication link, identification information of a receiving end apparatus on the first communication link, identification information of the transmitting end apparatus on the second communication link, and identification information of a receiving end apparatus on the second communication link.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the method provided in the ninth aspect may further include: The second apparatus receives the first information on the fourth resource on the fourth communication link.

In an embodiment, the method provided in the ninth aspect may further include: The second apparatus sends third indication information, where the third indication information indicates one or more of the following: a size of the first indication information, a quantity of links corresponding to the first indication information, or a quantity of time-frequency resources indicated by the first indication information.

In an embodiment, the method provided in the ninth aspect may further include: The second apparatus receives first feedback information, where the first feedback information indicates whether a first apparatus successfully receives the first information.

In an embodiment, the method provided in the ninth aspect may further include: The second apparatus sends fourth indication information, where the fourth indication information indicates one or more of the following: a size of the second indication information, a quantity of links corresponding to the second indication information, or a quantity of time-frequency resources indicated by the second indication information.

In an embodiment, the first apparatus is a terminal apparatus, and the second apparatus is a network apparatus.

In addition, for technical effects of the ninth aspect, refer to the technical effects of the communication method according to the second aspect. Details are not described herein again.

According to a tenth aspect, a communication method is provided. The communication method includes: A first apparatus receives first indication information from a second apparatus, where the first indication information indicates a first resource on a first communication link and a second resource on a second communication link; and link types of the first communication link and the second communication link are different, or types of transmitting end apparatuses on the first communication link and the second communication link are different. A third apparatus receives the first indication information. The third apparatus sends first information on the first resource on the first communication link. The first apparatus receives the first information on the first resource on the first communication link, and receives the first information on the second resource on the second communication link.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

In this case, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates the first communication link between the third apparatus and the first apparatus and the second communication link between the second apparatus and the first apparatus.

In an embodiment, the first indication information may include at least one of the following: identification information of the transmitting end apparatus on the first communication link, identification information of a receiving end apparatus on the first communication link, identification information of the transmitting end apparatus on the second communication link, and identification information of a receiving end apparatus on the second communication link. The identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus.

In an embodiment, that the first apparatus receives the first information on the first resource on the first communication link, and receives the first information on the second resource on the second communication link may include: The first apparatus receives the first information on the first resource on the first communication link, and successfully performs decoding; and/or the first apparatus receives the first information on the second resource on the second communication link, and successfully performs decoding; or the first apparatus receives the first information on the first resource on the first communication link, the first apparatus receives the first information on the second resource on the second communication link, and combined decoding is successfully performed.

In an embodiment, the method provided in the tenth aspect may further include: The first apparatus receives second indication information. The third apparatus receives the second indication information, where the second indication information indicates a third resource on a third communication link. The third apparatus sends the first information on the third resource on the third communication link. The first apparatus receives the first information on the third resource on the third communication link.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, that the first apparatus receives the first information on the first resource on the first communication link, and receives the first information on the second resource on the second communication link; and that the first apparatus receives the first information on the third resource on the third communication link include: The first apparatus receives the first information on the first resource on the first communication link, and successfully performs decoding; the first apparatus receives the first information on the second resource on the second communication link, and successfully performs decoding; and/or the first apparatus receives the first information on the third resource on the third communication link, and successfully performs decoding; or the first apparatus receives the first information on the first resource on the first communication link, the first apparatus receives the first information on the second resource on the second communication link, or the first apparatus receives the first information on the third resource on the third communication link; and combined decoding on at least two pieces of the first information is successfully performed.

In an embodiment, the second indication information further indicates a fourth resource on the fourth communication link.

Further, the third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource may further include a third space domain resource, and the fourth resource may further include a fourth space domain resource.

In this case, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the method provided in the tenth aspect may further include: The first apparatus receives third indication information. The third apparatus receives the third indication information, where the third indication information indicates one or more of the following: a size of the first indication information, a quantity of links corresponding to the first indication information, or a quantity of time-frequency resources indicated by the first indication information.

In an embodiment, the method provided in the tenth aspect may further include: The first apparatus sends first feedback information, where the first feedback information indicates whether the first apparatus successfully receives the first information.

In an embodiment, the method provided in the tenth aspect may further include: The first apparatus receives fourth indication information. The third apparatus receives the fourth indication information, where the fourth indication information indicates one or more of the following: a size of the second indication information, a quantity of links corresponding to the second indication information, or a quantity of time-frequency resources indicated by the second indication information.

In an embodiment, the first apparatus is a terminal apparatus, and the third apparatus is a terminal apparatus.

In addition, for technical effects of the tenth aspect, refer to the technical effects of the communication method according to either the first aspect or the second aspect. Details are not described herein again.

According to an eleventh aspect, a communication apparatus is provided. The communication apparatus is configured to perform the communication method according to any embodiment of the first aspect to the fourth aspect or any embodiment of the sixth aspect to the ninth aspect.

In this application, the communication apparatus according to the eleventh aspect may be a terminal apparatus or a network apparatus, a chip (system) or another part or component that may be disposed in the terminal apparatus or the network apparatus, or a device including the terminal apparatus or the network apparatus.

It should be understood that the communication apparatus according to the eleventh aspect includes a corresponding module, unit, or means for implementing the communication method according to any one of the first aspect to the fourth aspect or the sixth aspect to the ninth aspect. The module, unit, or means may be implemented by hardware, software, or hardware executing corresponding software. The hardware or the software includes one or more modules or units configured to perform the functions in the foregoing communication method.

According to a twelfth aspect, a communication apparatus is provided. The communication apparatus includes a processor. The processor is configured to perform the communication method according to any embodiment of the first aspect to the fourth aspect or any embodiment of the sixth aspect to the ninth aspect.

In an embodiment, the communication apparatus according to the twelfth aspect may further include a transceiver. The transceiver may be a transceiver circuit or an interface circuit. The transceiver may be used by the communication apparatus according to the twelfth aspect to communicate with another communication apparatus.

In an embodiment, the communication apparatus according to the twelfth aspect may further include a memory. The memory and the processor may be integrated together, or may be disposed separately. The memory may be configured to store a computer program and/or data in the communication method according to any one of the first aspect to the fourth aspect or the sixth aspect to the ninth aspect.

In this application, the communication apparatus according to the twelfth aspect may be a terminal apparatus or a network apparatus, a chip (system) or another part or component that may be disposed in the terminal apparatus or the network apparatus, or a device including the terminal apparatus or the network apparatus.

According to a thirteenth aspect, a communication apparatus is provided. The communication apparatus includes a processor. The processor is coupled to a memory. The processor is configured to execute a computer program stored in the memory, so that the communication apparatus performs the communication method according to any embodiment of the first aspect to the fourth aspect or the sixth aspect to the ninth aspect.

In an embodiment, the communication apparatus according to the thirteenth aspect may further include a transceiver. The transceiver may be a transceiver circuit or an interface circuit. The transceiver may be used by the communication apparatus according to the thirteenth aspect to communicate with another communication apparatus.

In this application, the communication apparatus according to the thirteenth aspect may be a terminal apparatus or a network apparatus, a chip (system) or another part or component that may be disposed in the terminal apparatus or the network apparatus, or a device including the terminal apparatus or the network apparatus.

According to a fourteenth aspect, a communication apparatus is provided, and includes a processor and a memory. The memory is configured to store a computer program. When the processor executes the computer program, the communication apparatus is enabled to perform the communication method according to any embodiment of the first aspect to the fourth aspect or the sixth aspect to the ninth aspect.

In an embodiment, the communication apparatus according to the fourteenth aspect may further include a transceiver. The transceiver may be a transceiver circuit or an interface circuit. The transceiver may be used by the communication apparatus according to the fourteenth aspect to communicate with another communication apparatus.

In this application, the communication apparatus according to the fourteenth aspect may be a terminal apparatus or a network apparatus, a chip (system) or another part or component that may be disposed in the terminal apparatus or the network apparatus, or a device including the terminal apparatus or the network apparatus.

According to a fifteenth aspect, a communication apparatus is provided, and includes a processor. The processor is configured to: be coupled to a memory; and after reading a computer program in the memory, perform, based on the computer program, the communication method according to any embodiment of the first aspect to the fourth aspect or the sixth aspect to the ninth aspect.

In an embodiment, the communication apparatus according to the fifteenth aspect may further include a transceiver. The transceiver may be a transceiver circuit or an interface circuit. The transceiver may be used by the communication apparatus according to the fifteenth aspect to communicate with another communication apparatus.

In this application, the communication apparatus according to the fifteenth aspect may be a terminal apparatus or a network apparatus, a chip (system) or another part or component that may be disposed in the terminal apparatus or the network apparatus, or a device including the terminal apparatus or the network apparatus.

According to a sixteenth aspect, a processor is provided. The processor is configured to perform the communication method according to any embodiment of the first aspect to the fourth aspect or the sixth aspect to the ninth aspect.

According to a seventeenth aspect, a communication system is provided. The communication system includes one or more terminal devices and one or more network devices.

According to an eighteenth aspect, a computer-readable storage medium is provided, and includes a computer program or instructions. When the computer program or the instructions are run on a computer, the computer is enabled to perform the communication method according to any embodiment of the first aspect to the fourth aspect or the sixth aspect to the ninth aspect.

According to a nineteenth aspect, a computer program product is provided, and includes a computer program or instructions. When the computer program or the instructions are run on a computer, the computer is enabled to perform the communication method according to any embodiment of the first aspect to the fourth aspect or the sixth aspect to the ninth aspect.

In addition, for technical effects of the eleventh aspect to the nineteenth aspect, refer to the technical effects of the communication method according to any one of the first aspect to the fourth aspect or the sixth aspect to the ninth aspect. Details are not described herein again.

### BRIEF DESCRIPTION OF DRAWINGS

FIG. 1 is a diagram of a data flow direction of Uu communication according to an embodiment of this application;

FIG. 2 is a diagram of a data flow direction of sidelink communication according to an embodiment of this application;

FIG. 3 is a diagram of a system architecture in an industrial manufacturing scenario according to an embodiment of this application;

FIG. 4 is a diagram of a data flow direction of two-step Uu communication according to an embodiment of this application;

FIG. 5 is a diagram of a data flow direction according to an embodiment of this application;

FIG. 6 is a diagram of an architecture of a communication system according to an embodiment of this application;

FIG. 7 is a schematic flowchart of a communication method according to an embodiment of this application;

FIG. 8 is a schematic flowchart of another communication method according to an embodiment of this application;

FIG. 9 is a schematic flowchart of another communication method according to an embodiment of this application;

FIG. 10 is a schematic flowchart of another communication method according to an embodiment of this application;

FIG. 11 is a diagram 1 of a structure of a communication apparatus according to an embodiment of this application; and

FIG. 12 is a diagram 2 of a structure of a communication apparatus according to an embodiment of this application.

### DESCRIPTION OF EMBODIMENTS

The following first describes technical terms in embodiments of this application.

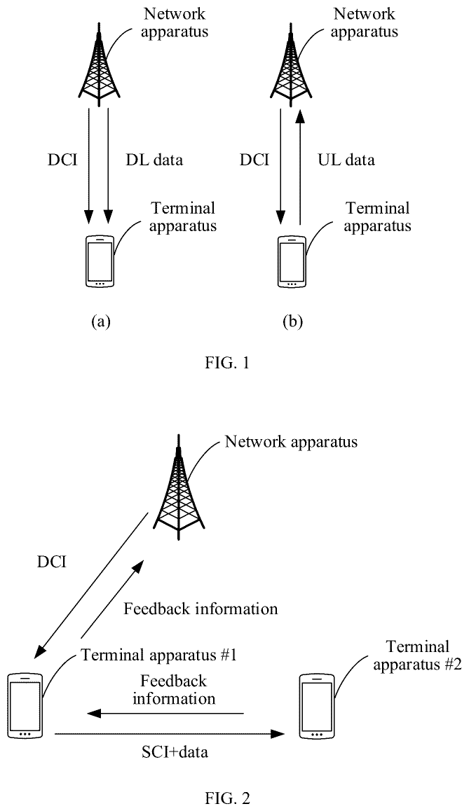

Uu communication is communication between a network apparatus, for example, a base station, and a terminal apparatus, where the network apparatus communicates with the terminal apparatus through a Uu interface. The Uu communication includes a downlink transmission procedure and an uplink transmission procedure. As shown in (a) in FIG. 1, the downlink transmission procedure of the Uu communication includes: The network apparatus sends downlink DCI to the terminal apparatus, where the DL DCI indicates a resource used by the terminal apparatus to receive data sent by the network apparatus. After receiving the DL DCI, the terminal apparatus may receive the DL data on the resource indicated by the DL DCI.

As shown in (b) in FIG. 1, the uplink transmission procedure of the Uu communication includes: The network apparatus sends uplink DCI to the terminal apparatus, where the UL DCI indicates a resource used by the terminal apparatus to send data to the network apparatus. After receiving the UL DCI, the terminal apparatus may send the UL data on the resource indicated by the UL DCI.

Sidelink (SL) communication is communication between terminal apparatuses. The SL communication includes a communication manner based on network apparatus scheduling and a communication manner of autonomous selection. As shown in FIG. 2, in the communication manner based on network apparatus scheduling, the network apparatus may send DCI to a terminal apparatus #1 for sending data. The terminal apparatus #1 receives the DCI, and sends, based on the DCI, sidelink control information (SCI) and the data to a terminal apparatus #2 for receiving the data. The terminal apparatus #2 receives the SCI through blind detection, and receives the data based on the SCI. The DCI may indicate related configuration information, for example, a resource, used by the terminal apparatus #1 to send the data to the terminal apparatus #2.

In the communication manner of autonomous selection, a network apparatus configures, in a semi-static manner, a resource for a data transmission between the terminal apparatuses. The terminal apparatus #1 for sending the data may determine, in a sensing manner, an available resource in the resource for the data transmission between the terminal apparatuses, and transmit the SCI and the data on the available resource. The terminal apparatus #2 for receiving the data may receive the SCI through the blind detection, thereby receiving the data based on the SCI. Semi-static configuration of the resource for the data transmission between the terminal apparatuses may be implemented by using radio resource control (RRC) signaling, or the RRC signaling and the DCI. Details are not described herein again.

It may be understood that the SCI may include first-stage SCI and second-stage SCI. A format of the first-stage SCI may be an SCI format 1-A, and a format of the second-stage SCI may include an SCI format 2-A and an SCI format 2-B.

In ultra-reliable low-latency communication (URLLC), there is a case in which different terminal apparatuses communicate with each other, for example, communication in an industrial manufacturing scenario. In the industrial manufacturing scenario, a manufacturing device in a smart factory accesses enterprise cloud or an onsite control system through a cellular network, and collects onsite environment data and production data, to analyze a production status in time, and implement an unmanned and wireless production line Smart industrial manufacturing has a quite high requirement on technical performance, and high-end manufacturing has a quite high requirement on latency and stability of a workshop device. An industry of the smart factory has put forward a quite specific performance requirement. For example, in a service area with no more than 50 users, in end-to-end latency of 1 millisecond (ms), communication service availability of a data packet with a size of 40 bytes is between 99.9999% and 99.999999%. The communication service availability may also be referred to as communication system availability (CSA) or communication reliability. The communication service availability includes whether a communication service is available. If a data packet received by a receiving end is damaged or not timely, for example, latency exceeds allowed maximum end-to-end latency, the service is considered unavailable.

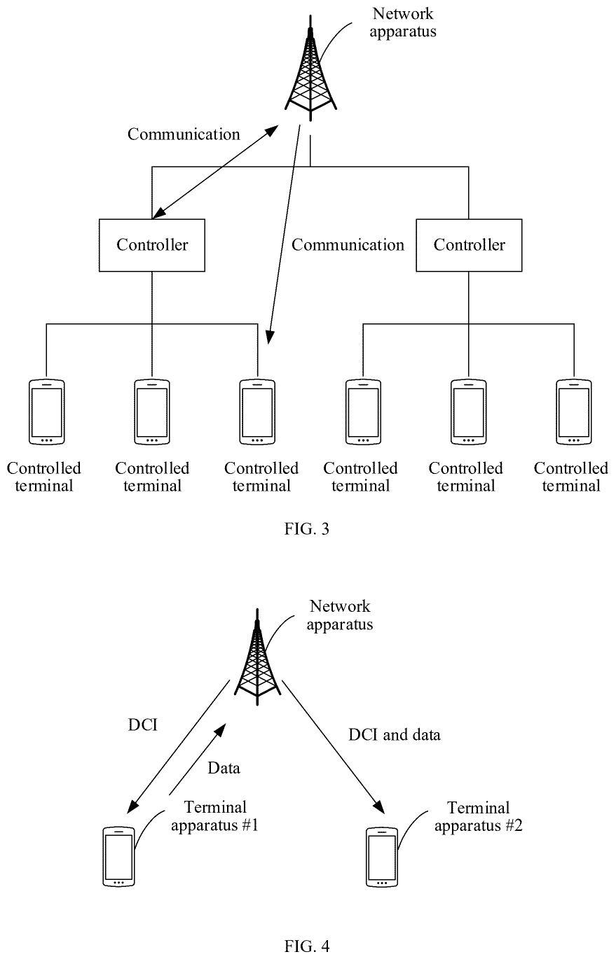

In an actual industrial scenario, a dual-layer structure is generally used for deployment. As shown in FIG. 3, the dual-layer structure includes the network apparatus, controllers, and controlled terminals. The network apparatus may be a radio access network device, for example, the base station. When the controllers communicate with the controlled terminals, the controllers need to communicate with the network apparatus, and then the network apparatus communicates with the controlled terminals. An interaction procedure is complex, and therefore high latency is caused. For example, the controllers may be terminal apparatuses. The controlled terminals may be controlled terminal apparatuses.

In an embodiment, when the different terminal apparatuses communicate with each other, a 2-step Uu communication manner may be used. As shown in FIG. 4, the network apparatus may send DCI #1 to a terminal apparatus #1, where the DCI #1 indicates a resource #1 used by the terminal apparatus #1 to send data. The terminal apparatus #1 sends the data to the network apparatus based on the resource #1 indicated by the DCI #1. The network apparatus sends DCI #2 to a terminal apparatus #2, where the DCI #2 indicates a resource #2 used by the network apparatus to send the data to the terminal apparatus #2. After receiving the data from the terminal apparatus #1, the network apparatus sends the data to the terminal apparatus #2 on the resource #2. In this solution, because data needs to be transmitted from the terminal apparatus #1 to the network apparatus, and then transmitted by the network apparatus to the apparatus #2, there is a severe problem of high latency.

In an embodiment, when the different terminal apparatuses communicate with each other, the SL communication may alternatively be used. For an embodiment, refer to the related descriptions of FIG. 2. However, in the communication manner based on network apparatus scheduling in the SL communication, latency of communication based on network apparatus scheduling is high, and the terminal apparatus #2 needs to perform blind detection, resulting in high complexity. Consequently, a problem of high latency and a problem of high power consumption are caused. In addition, in this solution, control signaling overheads are high, and there are a large quantity of repeatedly indicated information fields in a transmission mode based on network apparatus scheduling. In a scenario with a large quantity of users, for example, a factory, resource overheads are high. In the communication manner of autonomous selection in the SL communication, because the resource is semi-statically configured, resource usage is inflexible. Consequently, resource utilization is low, and a requirement in the scenario with the large quantity of users cannot be supported. In addition, the terminal apparatus #2 may send feedback information, for example, a hybrid automatic repeat request-acknowledgement (HARQ-ACK), to the terminal apparatus #1 based on a data receiving result, and then the terminal apparatus #1 transmits the received feedback information to the network apparatus. It can be learned that a transmission of the feedback information needs to traverse two different paths in sequence. Consequently, a problem of high latency of a data retransmission is caused.

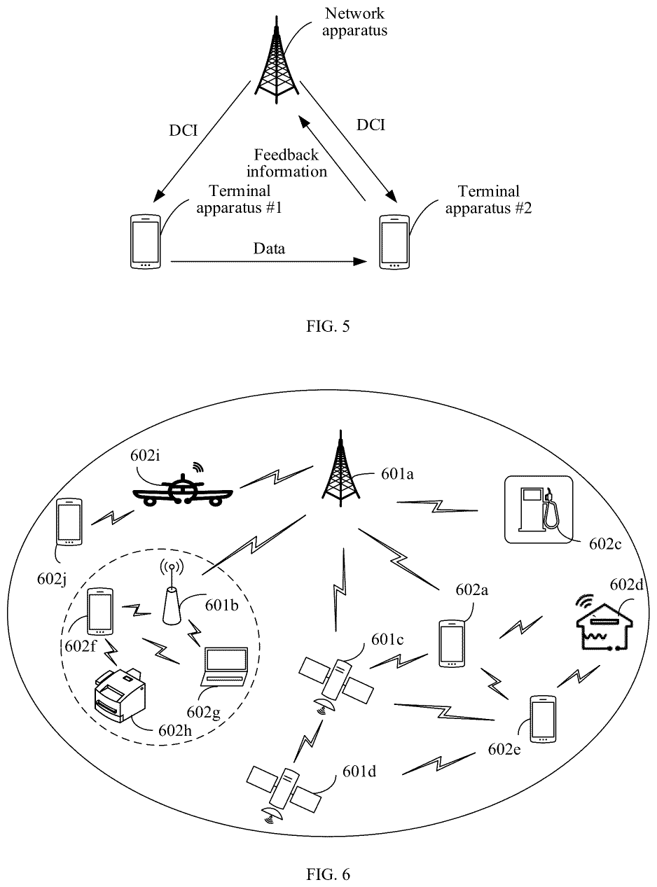

In an embodiment, when the different terminal apparatuses communicate with each other, as shown in FIG. 5, the network apparatus may send DCI, where the DCI indicates a resource #1 used by a terminal apparatus #1 to send data to a terminal apparatus #2. The terminal apparatus #1 sends the data on the resource #1 indicated by the DCI. The terminal apparatus #2 receives the data sent by the terminal apparatus #1 on the resource #1. In addition, the terminal apparatus #2 may further send feedback information to the network apparatus based on a data receiving result. For an embodiment of the feedback information, refer to the foregoing related descriptions of the feedback information. Details are not described herein again.

In conclusion, the foregoing solutions all have a problem of low reliability.

The following describes technical solutions in this application with reference to accompanying drawings.

The technical solutions in embodiments of this application may be applied to various communication systems, for example, a wireless fidelity (Wi-Fi) system, a vehicle to everything (V2X) communication system, a device-to-device (D2D) communication system, an internet of vehicles communication system, a 4th generation (4G) mobile communication system like a long term evolution (LTE) system and a worldwide interoperability for microwave access (WiMAX) communication system, a 5th generation (5G) mobile communication system like a new radio (NR) system, and a future communication system like a 6th generation (6G) mobile communication system.

All aspects, embodiments, or features are presented in this application by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may further be used.

In addition, in embodiments of this application, terms such as “example” and “for example” are for representing giving an example, an illustration, or descriptions. Any embodiment or design solution described as an “example” in this application should not be explained as being more preferred or having more advantages than another embodiment or design solution. Exactly, the term “example” is used to present a concept in a specific manner.

In embodiments of this application, “information”, “signal”, “message”, “channel”, and “signaling” may be interchangeably used sometimes. It should be noted that meanings expressed by the terms are consistent when differences between the terms are not emphasized. “Of (of)”, “corresponding, relevant”, and “corresponding” may be interchangeably used sometimes. It should be noted that meanings expressed by the terms are consistent when differences between the terms are not emphasized.

In embodiments of this application, sometimes a subscript like Wi may be incorrectly written in a non-subscript form like W1. Expressed meanings are consistent when differences are not emphasized.

The network architecture and the service scenario that are described in embodiments of this application are intended to describe the technical solutions in embodiments of this application more clearly, and do not constitute a limitation on the technical solutions provided in embodiments of this application. A person of ordinary skill in the art may know that with evolution of the network architecture and emergence of the new service scenario, the technical solutions provided in embodiments of this application are also applicable to similar technical problems.

For ease of understanding embodiments of this application, a communication system shown in FIG. 6 is first used as an example to describe in detail a communication system used in embodiments of this application. For example, FIG. 6 is a diagram of an architecture of a communication system to which a communication method according to an embodiment of this application is applicable.

FIG. 6 is a diagram of a possible non-limiting system. As shown in FIG. 6, the communication system includes at least one network apparatus (for example, a network apparatus 601a and a network apparatus 601d in FIG. 6, which are collectively referred to as network apparatuses 601) and at least one terminal apparatus (for example, a terminal apparatus 602a and a terminal apparatus 602c to a terminal apparatus 602j in FIG. 6, which are collectively referred to as terminal apparatuses 602). The communication system provided in FIG. 6 may further include another network apparatus, for example, a wireless relay device and/or a wireless backhaul device (not shown in FIG. 6). The terminal apparatus 602 is connected to the network apparatus 601 in a wireless manner. The network apparatus 601 may be connected to a core network in a wireless or wired manner.

There may be one or more terminal apparatuses such as a first terminal apparatus, a second terminal apparatus, and a third terminal apparatus. The terminal apparatus may be a terminal having a transceiver function, or may be a chip or a chip system disposed in the terminal. The terminal apparatus may also be referred to as user equipment (UE), an access terminal, a subscriber unit, a subscriber station, a mobile station (MS), a remote station, a remote terminal, a mobile device, a user terminal, a terminal, a wireless communication device, a user agent, or a user apparatus. The terminal apparatus in embodiments of this application may be a mobile phone, a cellular phone, a smartphone, a tablet computer (Pad), a wireless data card, a personal digital assistant (PDA), a wireless modem, a handheld device (handset), a laptop computer, a machine type communication (MTC) terminal, a computer with a wireless transceiver function, a virtual reality (VR) terminal, an augmented reality (AR) terminal, a smart home device (for example, a refrigerator, a television, an air conditioner, or an electricity meter), a smart robot, a robotic arm, a workshop device, a wireless terminal in self driving, a wireless terminal in industrial control a wireless terminal in integrated sensing and communication, a wireless terminal in self driving, a wireless terminal in remote medical, a wireless terminal in a smart grid, a wireless terminal in transportation safety, a wireless terminal in a smart city, a wireless terminal in a smart home, a vehicle-mounted terminal, a road side unit (RSU) having a terminal function, a flight device (for example, a smart robot, a hot air balloon, an uncrewed aerial vehicle, or an airplane), or the like. The terminal apparatus in this application may alternatively be an in-vehicle module, an automobile module, an onboard part, an automotive chip, or an on board unit that is built in a vehicle as one or more parts or units. The terminal apparatus may alternatively be another device having the terminal function. For example, the terminal apparatus may alternatively be a device that functions as a terminal in D2D communication. A device form of the terminal apparatus is not limited in embodiments of this application. An apparatus configured to implement a function of a terminal apparatus may be the terminal device, or may be an apparatus that can support the terminal device in implementing the function, for example, a chip system. The apparatus may be mounted in the terminal device or used together with the terminal device.

In embodiments of this application, the chip system may include a chip, or may include the chip and another discrete device.

There may be a plurality of network apparatuses, for example, a first network apparatus, a second network apparatus, and a third network apparatus. The network apparatus may be a device having a wireless transceiver function, or may be a chip or a chip system disposed in the device, and is located in an access network (AN) of the communication system, to provide an access service for the terminal. For example, the network apparatus may be referred to as a radio access network (RAN) device, and may be an access network device in a next-generation mobile communication system like 6G, for example, a 6G base station. Alternatively, in a next-generation mobile communication system, the network apparatus may be named in another manner, which falls within the protection scope of embodiments of this application. This is not limited in this application. Alternatively, the network apparatus may include a gNB in 5G, for example, a new radio (NR) system, or one or a group of antenna panels (including a plurality of antenna panels) of a base station in 5G, or may be a network node that constitutes a gNB, a transmission/reception node, a transmission point (transmission and reception point, TRP, or TP), or a transmission measurement function (TMF), for example, a central unit (CU), a distributed unit (DU), a CU-control plane (CP), a CU-user plane (UP), a radio unit (RU), an RSU having a base station function, a wireline access gateway, or a 5G core network element. Alternatively, the network apparatus may include an access point (AP) in a wireless fidelity (Wi-Fi) system, a wireless relay node, a wireless backhaul node, macro base stations in various forms, a micro base station (also referred to as a small cell), a relay station, an access point, a wearable device, a vehicle-mounted device, a satellite base station, a hot air balloon base station, and the like. The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that a network device may be a CU node, a DU node, or a device including the CU node and the DU node. In addition, the CU may be classified as a network device in an access network RAN, or the CU may be classified as a network device in the core network CN. This is not limited herein. In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any unit in the CU (or the CU-CP or the CU-UP), the DU, and the RU in this application may be implemented by using a software module, a hardware module, or a combination of the software module and the hardware module. A form of the network device is not limited in embodiments of this application. An apparatus configured to implement a function of the network device may be the network device, or may be an apparatus that can support the network device in implementing the function, for example, a chip system. The apparatus may be mounted in the network device or used together with the network device. It should be noted that communication methods provided in embodiments of this application are applicable to the network apparatus and the terminal apparatus that are shown in FIG. 6. For an embodiment, refer to the following method embodiments. Details are not described herein again.

It should be noted that the solutions in embodiments of this application may alternatively be applied to another communication system, and a corresponding name may alternatively be replaced with a name of a corresponding function in the other communication system.

It should be understood that FIG. 6 is merely a simplified diagram of an example for ease of understanding. The communication system may further include another network apparatus and/or another terminal apparatus that are/is not shown in FIG. 6.

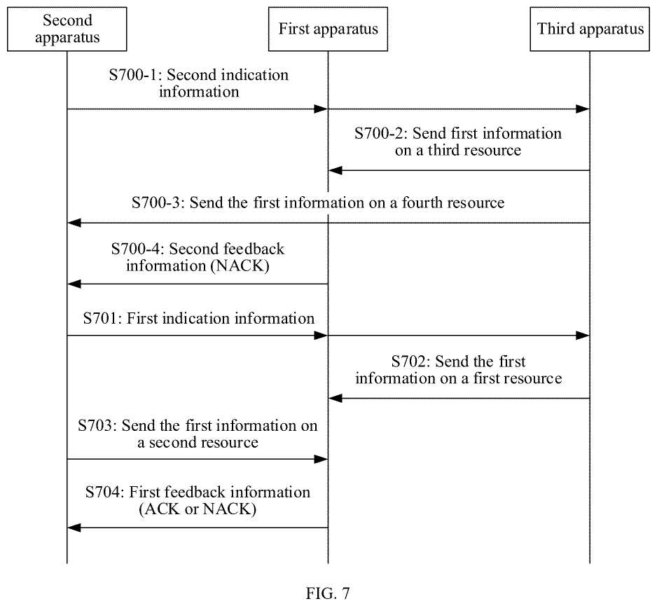

With reference to FIG. 7 to FIG. 10, the following describes the communication methods provided in embodiments of this application.

For example, FIG. 7 is a schematic flowchart 1 of a communication method according to an embodiment of this application. The communication method is applicable to communication between the network apparatus and two terminal apparatuses shown in FIG. 6.

As shown in FIG. 7, the communication method includes the following operations.

S701: A second apparatus sends first indication information. Accordingly, a first apparatus receives the first indication information, and a third apparatus receives the first indication information.

The first apparatus may be a terminal apparatus, the second apparatus may be a network apparatus, and the third apparatus may be a terminal apparatus.

The first indication information indicates a first resource and a second resource, the first resource is used by the third apparatus to send first information to the first apparatus, and the second resource is used by the second apparatus to send the first information to the first apparatus.

In other words, the first indication information is for triggering the third apparatus to send the first information to the first apparatus on the first resource, and triggering the second apparatus to send the first information to the first apparatus on the second resource.

The second resource may be used by the second apparatus to send the first information to the first apparatus, or may be used by a fourth apparatus to send the first information to the first apparatus. The fourth apparatus may be the same as the second apparatus, or the fourth apparatus may be different from the second apparatus. In other words, there may be one or more second apparatuses.

In an embodiment, the first resource may include a first time-frequency resource, and the second resource may include a second time-frequency resource. That is, time-frequency resources may be indicated for different communication links.

The first time-frequency resource and the second time-frequency resource each include a time domain resource and a frequency domain resource.

In an embodiment, the first time-frequency resource may be the same as the second time-frequency resource, to reduce time-frequency resource overheads, and improve time-frequency resource utilization. For example, the time domain resource in the first time-frequency resource is the same (partially the same or completely the same) as the time domain resource in the second time-frequency resource, and the frequency domain resource in the first time-frequency resource is the same (for example, partially the same or completely the same) as the frequency domain resource in the second time-frequency resource. For example, the time domain resources in the first time-frequency resource and the second time-frequency resource each include a symbol 0 to a symbol 13, and the frequency domain resources in the first time-frequency resource and the second time-frequency resource each include a subcarrier 0 to a subcarrier 11.

In an embodiment, the first time-frequency resource may be different from the second time-frequency resource, to avoid communication interference between different apparatuses, and reduce a requirement on demodulation performance of a receiver. This is applicable to devices in more forms. In addition, decoupling of time-frequency resources of the different apparatuses can also improve communication flexibility. For example, the time domain resource in the first time-frequency resource is different from the time domain resource in the second time-frequency resource, and/or the frequency domain resource in the first time-frequency resource is different from the frequency domain resource in the second time-frequency resource. For example, the time domain resource in the first time-frequency resource includes a symbol 0 to a symbol 6, and the time domain resource in the second time-frequency resource includes a symbol 7 to a symbol 13; and/or the frequency domain resource in the first time-frequency resource includes a subcarrier 0 to a subcarrier 5, and/or the frequency domain resource in the second time-frequency resource includes a subcarrier 6 to a subcarrier 11.

It may be understood that a symbol in this embodiment of this application may be a time domain symbol, for example, an orthogonal frequency division multiplexing symbol or another possible time domain symbol. Details are not described herein again.

In an embodiment, the first resource may further include a first space domain resource, and the second resource may further include a second space domain resource. That is, space domain resources may be indicated for the different communication links, to perform beam alignment, thereby improving signal transmission communication reliability.

A space domain resource may alternatively be understood as a beam. The space domain resource may be indicated by quasi-colocation relationship (QCL) information. Details are not described subsequently again. For example, the first space domain resource may be indicated by first QCL information, and the second space domain resource may be indicated by second QCL information.

The QCL information indicates QCL between antenna ports. The QCL information may include one or more of the following: channel state information reference signal (CSI-RS) resource identification information, sounding reference signal (SRS) resource identification information, or synchronization signal and physical broadcast channel block (SSB) identification information. The CSI-RS resource identification information indicates a CSI-RS resource, the SRS resource identification information indicates an SRS resource, and the SSB identification information indicates an SSB.

It may be understood that the QCL between the antenna ports indicates that signals sent through the antenna ports undergo same large-scale fading, and have a same large-scale property parameter. For example, when it is stated that an antenna port A and an antenna port B satisfy the QCL, it means that a channel large-scale property parameter obtained through estimation from a signal on the antenna port A is also applicable to a signal on the antenna port B. A large-scale property includes one or more of the following: delay spread, Doppler spread, a Doppler frequency shift, an average channel gain, an average delay, an angle of arrival (AoA), angle of arrival spread (AAS), an angle of departure (AoD), angle of departure spread (ADS), or a spatial correlation. It may be understood that the large-scale property herein is merely used as an example. In an embodiment, the large-scale property may further include other information. Details are not described herein again.

A link used by the third apparatus to send the first information to the first apparatus on the first resource is a first communication link, and a link used by the second apparatus to send the first information to the first apparatus on the second resource is a second communication link.

In an embodiment, the first indication information further indicates the first communication link and the second communication link.

In an embodiment, the first indication information may indicate the first communication link and the second communication link in the following manner: The first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus. In this way, an apparatus that receives the first indication information can determine, based on the first indication information, whether to receive information on the first resource and the second resource, thereby avoiding receiving unnecessary information, to reduce overheads.

For ease of understanding, the following describes the first indication information based on specific cases.

Case 1: The first time-frequency resource is different from the second time-frequency resource. In this case, the first indication information may separately indicate the first time-frequency resource and the second time-frequency resource.

In an embodiment, the first indication information may include at least one piece of the following information of each communication link: identification information of an apparatus for sending the first information, identification information of an apparatus for receiving the first information, and time-frequency resource configuration information. It may be understood that identification information of an apparatus may identify the apparatus. One piece of time-frequency resource configuration information may indicate a time domain location and a frequency domain location of at least one time-frequency resource. For example, the first indication information may indicate identification information of an apparatus for sending the first information on the first communication link, identification information of an apparatus for receiving the first information on the first communication link, and configuration information of the first time-frequency resource on the first communication link. The first indication information may indicate the second resource by indicating the following content: identification information of an apparatus for sending the first information on the second communication link, identification information of an apparatus for receiving the first information on the second communication link, and configuration information of the second time-frequency resource on the second communication link.

It may be understood that the first indication information may further indicate a space domain resource in the first resource and a space domain resource in the second resource. For example, the first indication information may indicate the first space domain resource in the first resource and the second space domain resource in the second resource. The first indication information may indicate a space domain resource on a communication link by using QCL information corresponding to the communication link.

For example, in this embodiment of this application, the first indication information may indicate the first space domain resource by using the first QCL information corresponding to the first communication link, and indicate the second space domain resource by using the second QCL information corresponding to the second communication link.

A communication link may correspond to a combination of an apparatus for sending the first information and an apparatus for receiving the first information on the communication link. Details are not described subsequently again. For the first information triggered by using the first indication information, apparatuses for sending the first information include the second apparatus and the third apparatus, and the apparatus for receiving the first information includes the first apparatus. Therefore, in this embodiment of this application, the first indication information may indicate the identification information of the third apparatus, the identification information of the first apparatus, the configuration information of the first time-frequency resource, and the first QCL information; and the identification information of the second apparatus, the identification information of the first apparatus, the configuration information of the second time-frequency resource, and the second QCL information. In this way, the first resource and the second resource may be indicated.

In some embodiments, the first time-frequency resource is related to the second time-frequency resource. In this case, when indicating the first time-frequency resource and the second time-frequency resource, the first indication information may indicate a total time-frequency resource occupied by the first time-frequency resource and the second time-frequency resource, and a relationship between the first time-frequency domain resource, the second time-frequency domain resource, and the total time-frequency resource. For example, the first indication information may indicate that the total time-frequency resource occupied by the first time-frequency domain resource and the second time-frequency domain resource includes a time unit 1 to a time unit N1 and a frequency domain unit 1 to a frequency domain unit P1, and the first time-frequency domain resource occupies the first n1 time units and all the frequency domain units in the total time-frequency resource. In this case, the second time-frequency domain resource occupies the (n1+1)^{th} time unit to the N1^{th} time unit and all the frequency domain units in the total time-frequency resource. N1, P1, and n1 are all positive integers greater than 1, and n1<N1. For another example, the first indication information may indicate that the total time-frequency resource occupied by the first time-frequency domain resource and the second time-frequency domain resource includes a time unit 1 to a time unit N1 and a frequency domain unit 1 to a frequency domain unit P1, and the first time-frequency domain resource occupies the first p1 frequency domain units and all time units in the total time-frequency resource. In this case, the second time-frequency domain resource occupies the (p1+1)^{th} frequency domain unit to the P1^{th} frequency domain unit and all the time units in the total time-frequency resource. p1 is a positive integer greater than 1, and p1<P1.

It may be understood that a time unit may include one or more time domain symbols such as orthogonal frequency division multiplexing symbols. For example, the time unit may be a slot or a mini-slot A frequency domain unit may include one or more subcarriers, one or more resource blocks, or one or more resource block groups. The time unit and the frequency domain unit are not limited in this embodiment of this application.

Alternatively, a first correspondence between the first time-frequency resource and the second time-frequency resource is preconfigured in the first apparatus and the third apparatus. The first indication information may explicitly indicate the first time-frequency resource, and implicitly indicate the second time-frequency resource. In this case, both the first apparatus and the third apparatus may determine the second time-frequency resource based on the first time-frequency resource indicated by the first indication information and the first correspondence. In other words, the second time-frequency resource may be deduced based on the first time-frequency resource and the first correspondence.

For example, the first correspondence includes that a quantity of time units between a start time unit of the second time-frequency resource and a start time unit of the first time-frequency resource is k1, that a quantity of time units occupied by the first time-frequency resource is the same as a quantity of time units occupied by the second time-frequency resource, and that a frequency domain unit of the first time-frequency resource is the same as a frequency domain unit of the second time-frequency resource. Assuming that the first indication information explicitly indicates that the time units occupied by the first time domain resource include a time unit m1 to a time unit m1+2 and that frequency domain units occupied by the first time-frequency resource include a frequency domain unit q1 to a frequency domain unit q1+4, the time units occupied by the second time-frequency resource include a time unit m1+k1 to a time unit m1+k1+2, and frequency domain units occupied by the second time-frequency resource include the frequency domain unit q1 to the frequency domain unit q1+4. m1, k1, and q1 are all positive integers greater than 1. For another example, the first correspondence includes that a quantity of time units between a start time unit of the second time-frequency resource and an end time unit of the first time-frequency resource is k1.

For another example, the first correspondence includes that a quantity of frequency domain units between a start frequency domain unit of the second time-frequency resource and a start frequency domain unit of the first time-frequency resource is k2, that a quantity of frequency domain units occupied by the first time-frequency resource is the same as a quantity of frequency domain units occupied by the second time-frequency resource, and that a time unit of the first time-frequency resource is the same as a time unit of the second time-frequency resource. Assuming that the first indication information explicitly indicates that the first time domain resource occupies a time unit m2 to a time unit m2+2 and that the frequency domain units occupied by the first time-frequency resource include a frequency domain unit q2 to a frequency domain unit q2+4, time units occupied by the second time-frequency resource include the time unit m2 to the time unit m2+2, and the frequency domain units occupied by the second time-frequency resource include a frequency domain unit q2+k2 to a frequency domain unit q2+k2+4. m2, k2, and q2 are all positive integers greater than 1.

Case 2: The first time-frequency resource is the same as the second time-frequency resource. In this case, the first indication information may indicate one time-frequency resource, to indicate the first time-frequency resource and the second time-frequency resource.

In an embodiment, the first indication information may indicate a time-frequency resource on each communication link by using one piece of information; and for the communication link, indicate at least one piece of the following information of the communication link: identification information of an apparatus for sending the first information and identification information of an apparatus for receiving the first information.

For example, the first indication information may indicate time-frequency resource configuration information, identification information of an apparatus for sending the first information on the first communication link, identification information of an apparatus for receiving the first information on the first communication link, identification information of an apparatus for sending the first information on the second communication link, and identification information of an apparatus for receiving the first information on the second communication link.

It may be understood that the first indication information may further indicate a space domain resource on a communication link. For an embodiment, refer to the related descriptions in the case 1. Details are not described herein again.

Therefore, in this case, the first indication information may indicate the time-frequency resource configuration information, the identification information of the third apparatus, the identification information of the first apparatus, and the first QCL information; and the identification information of the second apparatus, the identification information of the first apparatus, and the second QCL information. In this way, the first resource and the second resource may be indicated.

The identification information of the first apparatus is information identifying the first apparatus, and may include an identifier of the first apparatus. The identification information of the second apparatus is information identifying the second apparatus, and may include an identifier of the second apparatus. The identification information of the third apparatus is information identifying the third apparatus, and may include an identifier of the third apparatus. It may be understood that identification information of an apparatus may alternatively be other possible information. This is not limited in this embodiment of this application.

In this embodiment of this application, the first indication information indicates the first resource and the second resource, the first resource is used by the third apparatus to send the first information to the first apparatus, and the second resource is used by the second apparatus to send the first information to the first apparatus. In other words, the first indication information indicates the first resource for communication through the first communication link and the second resource for communication through the second communication link. Link types of the first communication link and the second communication link are different, or types of the transmitting end apparatuses on the first communication link and the second communication link are different.

A link type may include a link for communication through a Uu interface or a link for SL communication. That the link types of the first communication link and the second communication link are different may be that the first communication link is a link for SL communication and that the second communication link is a link for communication through a Uu interface.

A type of a transmitting end apparatus may include a terminal apparatus or a network apparatus. That the types of the transmitting end apparatuses are different may mean that the second apparatus is a network apparatus and that the third apparatus is a terminal apparatus.

A sequence of content indicated by the first indication information is merely used as an example. In this embodiment of this application, the sequence of the content indicated by the first indication information is not limited.

In this embodiment of this application, the first indication information may be carried in a same piece of signaling or a same message, or may be carried in different signaling or messages. For example, the first indication information is carried in two pieces of signaling, where information indicating the first resource is carried in signaling 1, and information indicating the second resource is carried in signaling 2. In other words, the first indication information received by the first apparatus and the first indication information received by the third apparatus may be the same message, e.g., the same piece of signaling, or may be different messages, e.g., the different signaling. Signaling for carrying the first indication information may be DCI. In this way, the first indication information can be dynamically configured by using the DCI, so that configuration of the first indication information is more flexible. It should be understood that the first indication information may alternatively be carried in another possible message or other possible signaling. Details are not described herein again.

It may be understood that, when the signaling for carrying the first indication information is the DCI, a format of the DCI may be DCI 3_0 or another possible DCI format. Details are not described herein again.

The identification information of the first apparatus, the identification information of the second apparatus, and the identification information of the third apparatus may be allocated by the second apparatus. Therefore, the first apparatus may determine, based on the identification information of the first apparatus after receiving the first indication information, whether the first apparatus is an apparatus for sending the first information or an apparatus for receiving the first information. Similarly, the third apparatus may determine, based on the identification information of the third apparatus after receiving the first indication information, whether the third apparatus is an apparatus for sending the first information or an apparatus for receiving the first information.

When the first apparatus determines, based on the identification information of the first apparatus after receiving the first indication information, that the first apparatus is the apparatus for receiving the first information, and the third apparatus determines, based on the identification information of the third apparatus after receiving the first indication information, that the third apparatus is the apparatus for sending the first information, corresponding operations in the following S702 may be performed.

S702: The third apparatus sends the first information on the first resource. Accordingly, the first apparatus receives the first information sent by the third apparatus on the first resource.

It may be understood that the first information that is sent by the third apparatus on the first resource and that is received by the first apparatus is information obtained through a transmission of the first information through a channel between the first apparatus and the third apparatus. The information may be the same as or different from the first information.

S703: The second apparatus sends the first information on the second resource. Accordingly, the first apparatus receives the first information sent by the second apparatus on the second resource.

It may be understood that the first information that is sent by the second apparatus on the second resource and that is received by the first apparatus is information obtained through a transmission of the first information through a channel between the first apparatus and the second apparatus. The information may be the same as or different from the first information.

A sequence of S702 and S703 is not limited. For example, S702 may be performed before S703, S703 may be performed before S702, or S702 and S703 may be performed in parallel.

In an embodiment, that the first apparatus receives the first information sent by the third apparatus on the first resource, and receives the first information sent by the second apparatus on the second resource may include: The first apparatus receives the first information sent by the third apparatus on the first resource, and successfully performs decoding; the first apparatus receives the first information sent by the second apparatus on the second resource, and successfully performs decoding; or the first apparatus receives the first information sent by the third apparatus on the first resource, the first apparatus receives the first information sent by the second apparatus on the second resource, and combined decoding is successfully performed. In other words, the first apparatus successfully receives the first information. In other words, decoding, for example, separate decoding or combined decoding, needs to be performed on a same piece of information received on a plurality of communication links. In comparison with a solution of communication through a single communication link, even if decoding of the information on a communication link is unsuccessful, it is still possible that the information on another communication link can be successfully decoded or the combined decoding is successful, thereby improving communication reliability, reducing a quantity of retransmissions, and improving communication efficiency.

The combined decoding may be decoding, together, information received on at least two communication links. Details are not described herein again.

In an embodiment, that the first apparatus receives the first information sent by the third apparatus on the first resource, and receives the first information sent by the second apparatus on the second resource may include: The first apparatus receives the first information sent by the third apparatus on the first resource, and unsuccessfully performs decoding; the first apparatus receives the first information sent by the second apparatus on the second resource, and unsuccessfully performs decoding; and the first apparatus receives the first information sent by the third apparatus on the first resource, the first apparatus receives the first information sent by the second apparatus on the second resource, and unsuccessfully performs combined decoding. In other words, the first apparatus does not successfully receive the first information.

Based on the method provided in FIG. 7 and the method provided in the first aspect, the second apparatus may indicate, by using the first indication information, resources used by the different apparatuses to send the first information, e.g., resources for sending the first information on the different links, for example, the first resource and the second resource. The first apparatus may receive, based on the resources indicated by the second apparatus, the first information transmitted through the different links, thereby receiving information on the plurality of links, so that transmissions of the same piece of information on the plurality of links are implemented, to improve the communication reliability.

To feed back a decoding success or unsuccess state of the first information on the first apparatus to another apparatus, for example, the second apparatus, in time to improve the communication efficiency, the method provided in FIG. 7 may further include S704.

S704: The first apparatus sends first feedback information to the second apparatus. Accordingly, the second apparatus receives the first feedback information from the first apparatus.

The first feedback information indicates whether the first apparatus successfully receives the first information. When the first apparatus successfully receives the first information, the first feedback information indicates that the first apparatus has successfully received the first information. When the first apparatus does not successfully receive the first information, the first feedback information indicates that the first apparatus does not successfully receive the first information.

The first feedback information may be a HARQ. When the first apparatus successfully receives the first information, the first feedback information may be an ACK. When the first apparatus does not successfully receive the first information, the first feedback information may be a NACK.

In addition, power used by the first apparatus to send the first feedback information is related to a path loss between the first apparatus and the second apparatus. There is a correspondence between a communication link and a path loss on the communication link. Therefore, the path loss between the first apparatus and the second apparatus may be indicated by indicating an identifier of the communication link.

The path loss between the first apparatus and the second apparatus may be indicated by the first indication information. When second indication information is exchanged, the path loss between the first apparatus and the second apparatus may alternatively be indicated by the second indication information.

It may be understood that the foregoing S701 to S703 may be performed when neither the second apparatus nor the third apparatus sends the first information to the first apparatus. In other words, S701 to S703 may be a procedure of an initial transmission of the first information. Alternatively, the foregoing S701 to S703 may be performed when the third apparatus unsuccessfully transmits the first information to the first apparatus for a first time, or may be performed when the second apparatus and the third apparatus unsuccessfully transmit the first information to the first apparatus. In other words, S701 to S703 may be a procedure of a retransmission of the first information.

Assuming that the foregoing S701 to S703 are performed when the third apparatus unsuccessfully transmits the first information to the first apparatus for the first time, the method provided in FIG. 7 may further include S700-1 and S700-2.

S700-1: The second apparatus sends the second indication information. Accordingly, the first apparatus receives the second indication information from the second apparatus.

The third apparatus receives the second indication information from the second apparatus.

The second indication information indicates a third resource, and the third resource is used by the third apparatus to send the first information to the first apparatus.

In an embodiment, the third resource may include a third time-frequency resource.

In an embodiment, the third resource may further include a third space domain resource.

In this way, before the first information sent by the third apparatus on the first resource is received, and the first information sent by the second apparatus on the second resource is received, the first information sent by the third apparatus on the third resource can be received, so that the first apparatus can combine information in processes of the initial transmission and the retransmission to perform combined decoding, so that the communication reliability can be further improved.

In an embodiment, the second indication information may further indicate a fourth resource, and the fourth resource is used by the third apparatus to send the first information to the second apparatus; and the method provided in FIG. 7 may further include: The third apparatus sends the first information on the fourth resource. Accordingly, the second apparatus receives the first information sent by the third apparatus on the fourth resource.

In other words, the first indication information is for triggering the third apparatus to send the first information to the first apparatus on the third resource, and triggering the third apparatus to send the first information to the second apparatus on the fourth resource.

Further, the fourth resource may include a fourth time-frequency resource.

In an embodiment, the third time-frequency resource may be the same as the fourth time-frequency resource, to reduce time-frequency resource overheads, and improve time-frequency resource utilization. In addition, communication latency can be reduced. For example, a time domain resource in the third time-frequency resource is the same (partially the same or completely the same) as a time domain resource in the fourth time-frequency resource, and a frequency domain resource in the third time-frequency resource is the same (for example, partially the same or completely the same) as a frequency domain resource in the fourth time-frequency resource. For example, the time domain resources in the third time-frequency resource and the fourth time-frequency resource each include the symbol 0 to the symbol 13, and the frequency domain resources in the third time-frequency resource and the fourth time-frequency resource each include the subcarrier 0 to the subcarrier 11.

Alternatively, in an embodiment, the third time-frequency resource may be different from the fourth time-frequency resource, to avoid communication interference between different apparatuses, and reduce the requirement on the demodulation performance of the receiver. This is applicable to the devices in the more forms. In addition, decoupling of time-frequency resources of the different apparatuses can also improve the communication flexibility. For example, a time domain resource in the third time-frequency resource is different from a time domain resource in the fourth time-frequency resource, and/or a frequency domain resource in the third time-frequency resource is different from the frequency domain resource in the fourth time-frequency resource. For example, the time domain resource in the third time-frequency resource includes the symbol 0 to the symbol 6, and the time domain resource in the fourth time-frequency resource includes the symbol 7 to the symbol 13; and/or the frequency domain resource in the third time-frequency resource includes the subcarrier 0 to the subcarrier 5, and/or a frequency domain resource in the fourth time-frequency resource includes the subcarrier 6 to the subcarrier 11.

Further, the fourth resource may further include a fourth space domain resource. That is, space domain resources may be indicated for different communication links, to perform beam alignment, thereby further improving the communication reliability.

The third space domain resource may be indicated by third QCL information, and the fourth space domain resource may be indicated by fourth QCL information.

A link used by the third apparatus to send the first information to the first apparatus on the third resource is a third communication link, and a link used by the third apparatus to send the first information to the second apparatus on the fourth resource is a fourth communication link.

In an embodiment, the second indication information further indicates the third communication link and the fourth communication link.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be the identification information of the third apparatus, and the identification information of the receiving end apparatus on the third communication link may be the identification information of the first apparatus. The identification information of the transmitting end apparatus on the fourth communication link may be the identification information of the third apparatus, and the identification information of the receiving end apparatus on the fourth communication link may be the identification information of the second apparatus.

For ease of understanding, the following describes the second indication information based on specific cases.

Case 3: The third time-frequency resource is different from the fourth time-frequency resource. In this case, the second indication information may separately indicate the third time-frequency resource and the fourth time-frequency resource.

In an embodiment, the second indication information may include at least one piece of the following information of each communication link: identification information of an apparatus for sending the first information, identification information of an apparatus for receiving the first information, and time-frequency resource configuration information.

For example, the second indication information may indicate identification information of an apparatus for sending the first information on the third communication link, identification information of an apparatus for receiving the first information on the third communication link, and configuration information of the third time-frequency resource on the third communication link; and identification information of an apparatus for sending the first information on the fourth communication link, identification information of an apparatus for receiving the first information on the fourth communication link, and configuration information of the fourth time-frequency resource on the fourth communication link.

It may be understood that the second indication information may further indicate the space domain resource in the third resource and the space domain resource in the fourth resource. For example, the second indication information may indicate the third space domain resource in the third resource and the fourth space domain resource in the fourth resource. The second indication information may indicate a space domain resource on a communication link by indicating QCL information corresponding to the communication link.

For example, in this embodiment of this application, the second indication information may indicate the third space domain resource by using the third QCL information corresponding to the third communication link, and indicate the fourth space domain resource by using the fourth QCL information corresponding to the fourth communication link.

For the first information triggered by using the second indication information, the apparatus for sending the first information includes the third apparatus, and apparatuses for receiving the first information include the first apparatus and the second apparatus. Therefore, in this embodiment of this application, the second indication information may indicate the identification information of the third apparatus, the identification information of the first apparatus, the configuration information of the third time-frequency resource, and the third QCL information; and the identification information of the third apparatus, the identification information of the second apparatus, the configuration information of the fourth time-frequency resource, and the fourth QCL information. In this way, the third resource and the fourth resource may be indicated.

In some embodiments, a third time-frequency domain resource is related to a fourth time-frequency domain resource. In this case, when indicating the third time-frequency resource and the fourth time-frequency resource, the second indication information may indicate a total time-frequency resource occupied by the third time-frequency resource and the fourth time-frequency resource, and a relationship between the third time-frequency domain resource, the fourth time-frequency domain resource, and the total time-frequency resource. For example, the second indication information may indicate that the total time-frequency resource occupied by the third time-frequency domain resource and the fourth time-frequency domain resource includes a time unit 1 to a time unit N2 and a frequency domain unit 1 to a frequency domain unit P2, and the third time-frequency domain resource occupies the first n2 time units and all the frequency domain units in the total time-frequency resource. In this case, the fourth time-frequency domain resource occupies the (n2+1)^{th} time unit to the N2^{th} time unit and all the frequency domain units in the total time-frequency resource. N2, P2, and n2 are all positive integers greater than 1, and n2<N2. For another example, the second indication information may indicate that the total time-frequency resource occupied by the third time-frequency domain resource and the fourth time-frequency domain resource includes a time unit 1 to a time unit N2 and a frequency domain unit 1 to a frequency domain unit P2, and the third time-frequency domain resource occupies the first p2 frequency domain units and all time units in the total time-frequency resource. In this case, the fourth time-frequency domain resource occupies the (p2+1)^{th} frequency domain unit to the P2^{th} frequency domain unit and all the time units in the total time-frequency resource. p2 is a positive integer greater than 1, and p2<P2.

Alternatively, a second correspondence between the third time-frequency resource and the fourth time-frequency resource is preconfigured in the first apparatus and the second apparatus. The second indication information may explicitly indicate the third time-frequency resource, and implicitly indicate the fourth time-frequency resource. In this case, both the first apparatus and the second apparatus may determine the fourth time-frequency resource based on the third time-frequency resource indicated by the second indication information and the second correspondence. In other words, the fourth time-frequency resource may be deduced based on the third time-frequency resource and the second correspondence.

For example, the second correspondence includes that a quantity of time units between a start time unit of the fourth time-frequency resource and an start time unit of the third time-frequency resource is k3, that a quantity of time units occupied by the third time-frequency resource is the same as a quantity of time units occupied by the fourth time-frequency resource, and that a frequency domain unit of the third time-frequency resource is the same as a frequency domain unit of the fourth time-frequency resource. Assuming that the second indication information explicitly indicates that the third time domain resource occupies a time unit m3 to a time unit m3+2 and that frequency domain units occupied by the third time-frequency resource include a frequency domain unit q3 to a frequency domain unit q3+4, the time units occupied by the fourth time-frequency resource include a time unit m3+k3 to a time unit m3+k3+2, and frequency domain units occupied by the fourth time-frequency resource include the frequency domain unit q3 to the frequency domain unit q3+4. m3, k3, and q3 are all positive integers greater than 1.

For example, the second correspondence includes that a quantity of frequency domain units between a start frequency domain unit of the fourth time-frequency resource and an start frequency domain unit of the third time-frequency resource is k4, that a quantity of frequency domain units occupied by the third time-frequency resource is the same as a quantity of frequency domain units occupied by the fourth time-frequency resource, and that a time unit of the third time-frequency resource is the same as a time unit of the fourth time-frequency resource. Assuming that the second indication information explicitly indicates that the third time domain resource occupies a time unit m4 to a time unit m4+2 and that the frequency domain units occupied by the third time-frequency resource include a frequency domain unit q4 to a frequency domain unit q4+4, time units occupied by the fourth time-frequency resource include the time unit m4 to the time unit m4+2, and the frequency domain units occupied by the fourth time-frequency resource include a frequency domain unit q4+k4 to a frequency domain unit q4+k4+4. m4, k4, and q4 are all positive integers greater than 1.

Case 4: The third time-frequency resource is the same as the fourth time-frequency resource. In this case, the second indication information may indicate one time-frequency resource, to indicate the third time-frequency resource and the fourth time-frequency resource.

In an embodiment, the second indication information may indicate the time-frequency resources on the third communication link and the fourth communication link by using one piece of information; and for each communication link, indicate at least one piece of the following information of the communication link: identification information of an apparatus for sending the first information and identification information of an apparatus for receiving the first information.

For example, the second indication information may indicate time-frequency resource configuration information, identification information of an apparatus for sending the first information on the third communication link, identification information of an apparatus for receiving the first information on the third communication link, identification information of an apparatus for sending the first information on the fourth communication link, and identification information of an apparatus for receiving the first information on the fourth communication link.

It may be understood that the second indication information may further indicate a space domain resource on a communication link. For an embodiment, refer to the related descriptions in the case 3. Details are not described herein again.

Therefore, in this case, the second indication information may indicate the time-frequency resource configuration information, the identification information of the third apparatus, the identification information of the first apparatus, and the third QCL information; and the identification information of the third apparatus, the identification information of the second apparatus, and the fourth QCL information. In this way, the third resource and the fourth resource may be indicated. In this embodiment of this application, the second indication information indicates the third resource. In other words, the second indication information indicates the third resource for communication through the third communication link. The second indication information indicates the fourth resource. In other words, the second indication information indicates the fourth resource for communication through the fourth communication link. Link types of the third communication link and the fourth communication link are different, or types of receiving end apparatuses on the third communication link and the fourth communication link are different.

For a link type embodiment, refer to the related descriptions in S701. That the link types of the third communication link and the fourth communication link are different may be that the third communication link is a link for SL communication and that the fourth communication link is a link for communication through a Uu interface. A type of a receiving end apparatus may include a terminal apparatus or a network apparatus. That the types of the receiving end apparatuses are different may mean that the first apparatus is a network apparatus and that the second apparatus is a terminal apparatus.

It may be understood that one or more of the following on the third communication link and the fourth communication link may be the same: transport block sizes (TBSs), modulation and coding schemes (MCSs), redundancy versions (RVs), HARQ process identifiers (IDs), and demodulation reference signal (DMRS) sequence identifiers. A HARQ process identifier may also be referred to as a process number for a transmission of the first information.

It may be understood that, when signaling for carrying the second indication information is DCI, a format of the DCI may be DCI 3_0 or another possible DCI format. Details are not described herein again.

The first apparatus may determine, based on the identification information of the first apparatus after receiving the second indication information, whether the first apparatus is an apparatus for sending the first information or an apparatus for receiving the first information. Similarly, the second apparatus may determine, based on the identification information of the second apparatus, whether the second apparatus is an apparatus for sending the first information or an apparatus for receiving the first information.

When the first apparatus determines, based on the identification information of the first apparatus after receiving the second indication information, that the first apparatus is the apparatus for receiving the first information, corresponding operations in the following S700-2 may be performed. When the second apparatus determines, based on the identification information of the second apparatus, that the second apparatus is the apparatus for receiving the first information, corresponding operations in the following S700-3 may be performed.

S700-2: The third apparatus sends the first information on the third resource. Accordingly, the first apparatus receives the first information sent by the third apparatus on the third resource.

In this way, before the first information sent by the third apparatus on the first resource is received, and the first information sent by the second apparatus on the second resource is received, the first information sent by the third apparatus on the third resource can be received, so that the first apparatus can combine the information in processes of the initial transmission and the retransmission to perform combined decoding, so that the communication reliability can be further improved.

In an embodiment, that the first apparatus receives the first information sent by the third apparatus on the first resource, and receives the first information sent by the second apparatus on the second resource; and that the first apparatus receives the first information sent by the third apparatus on the third resource may include: The first apparatus receives the first information sent by the third apparatus on the first resource, and successfully performs decoding; and/or the first apparatus receives the first information sent by the second apparatus on the second resource, and successfully performs decoding; or the first apparatus receives the first information sent by the third apparatus on the first resource, the first apparatus receives the first information sent by the second apparatus on the second resource, or the first apparatus receives the first information sent by the third apparatus on the third resource; and combined decoding on at least two pieces of the first information is successfully performed. In other words, the first apparatus successfully receives the first information.

In other words, decoding, for example, separate decoding or combined decoding, needs to be performed on the same piece of information received on a plurality of communication links in the initial transmission and the retransmission. In comparison with the solution of communication through the single communication link, even if decoding of the information on the communication link is unsuccessful, it is still possible that the information on the other communication link can be successfully decoded or the combined decoding is successful, thereby improving the communication reliability, reducing the quantity of retransmissions, and improving the communication efficiency.

Alternatively, in an embodiment, that the first apparatus receives the first information sent by the third apparatus on the first resource, and receives the first information sent by the second apparatus on the second resource; and that the first apparatus receives the first information sent by the third apparatus on the third resource may include: The first apparatus receives the first information sent by the third apparatus on the first resource, and unsuccessfully performs decoding; the first apparatus receives the first information sent by the second apparatus on the second resource, and unsuccessfully performs decoding; and combined decoding on any plurality of the following is unsuccessfully performed: the first information that is sent by the third apparatus on the first resource and that is received by the first apparatus, the first information that is sent by the second apparatus on the second resource and that is received by the first apparatus, or the first information that is sent by the third apparatus on the third resource and that is received by the first apparatus. In other words, the first apparatus does not successfully receive the first information.

It may be understood that, in this embodiment of this application, the first information that is sent by the third apparatus on the first resource and that is received by the first apparatus is the information obtained through the transmission of the first information through the channel. The first information that is sent by the third apparatus on the first resource and that is received by the first apparatus may be the same as the first information, or may be different from the first information. The first information that is sent by the second apparatus on the second resource and that is received by the first apparatus is the information obtained through the transmission of the first information through the channel. The first information that is sent by the second apparatus on the second resource and that is received by the first apparatus may be the same as the first information, or may be different from the first information. The first information that is sent by the third apparatus on the third resource and that is received by the first apparatus is information obtained through a transmission of the first information through a channel. The first information that is sent by the third apparatus on the third resource and that is received by the first apparatus may be the same as the first information, or may be different from the first information. The first information that is sent by the third apparatus on the fourth resource and that is received by the second apparatus is information obtained through a transmission of the first information through a channel. The first information that is sent by the third apparatus on the fourth resource and that is received by the second apparatus may be the same as the first information, or may be different from the first information.

In addition, it should be understood that S700-2 may be the initial transmission of the first information.

S700-3: The third apparatus sends the first information on the fourth resource. Accordingly, the second apparatus receives the first information sent by the third apparatus on the fourth resource.

A sequence of S700-2 and S700-3 is not limited. For example, S700-2 may be performed before S700-3, S700-3 may be performed before S700-2, or S700-2 and S700-3 may be performed in parallel.

In this way, the third apparatus can send the first information on the third communication link and the fourth communication link. In other words, the third apparatus can back up the first information to the second apparatus. In this way, the second apparatus can send the first information to the first apparatus, and there are more communication links for transmitting the first information to the first apparatus, so that the communication reliability can be improved.

In S700-2, when the first information that is sent by the third apparatus on the third resource and that is received by the first apparatus is different from the first information, the communication method provided in FIG. 7 may further include S700-4.

S700-4: The first apparatus sends second feedback information to the second apparatus. Accordingly, the second apparatus receives the second feedback information from the first apparatus.

The second feedback information indicates that the first apparatus does not successfully receive the first information. That the first information is not successfully received may also be referred to as that receiving of the first information is unsuccessful.

The second feedback information may be a hybrid automatic repeat request (HARQ), for example, a negative acknowledgement (NACK).

It may be understood that, in this embodiment of this application, in S700-2, when the first information that is sent by the third apparatus on the third resource and that is received by the first apparatus is the same as the first information, S701 to S703 may not be performed. In this case, the second feedback information indicates that the first apparatus successfully receives the first information. For example, the second feedback information may be an acknowledgement (ACK).

It may be understood that there is a preset correspondence between a resource for carrying the second feedback information and a sounding reference signal (SRS) or a channel state information reference signal (CSI-RS). Therefore, the resource for carrying the second feedback information may be determined based on the SRS or the CSI-RS.

In addition, power used by the first apparatus to send the second feedback information is related to the path loss between the first apparatus and the second apparatus. There is a correspondence between the communication link and the path loss on the communication link. Therefore, the path loss between the first apparatus and the second apparatus may be indicated by indicating the identifier of the communication link.

The path loss between the first apparatus and the second apparatus may be indicated by the second indication information, or may be indicated by signaling or a message other than the second indication information.

It may be understood that, in this embodiment of this application, the first information sent by the third apparatus on the first resource, the first information sent by the third apparatus on the third resource, the first information sent by the third apparatus on the fourth resource, and the first information sent by the second apparatus on the second resource may be same data, for example, may be a same RV of the same data or different RVs of the same data. For another example, RVs of at least two of the first information sent by the third apparatus on the first resource, the first information sent by the third apparatus on the third resource, the first information sent by the third apparatus on the fourth resource, and the first information sent by the second apparatus on the second resource are the same.

In some embodiments, the method provided in FIG. 7 may further include: The second apparatus sends third indication information. Accordingly, the first apparatus receives the third indication information, and the third apparatus receives the third indication information.

The third indication information may indicate one or more of the following: a format of the first indication information, a size of the first indication information, a quantity of links corresponding to the first indication information, and whether the first indication information includes configuration information of two time-frequency resources.

The third indication information may be carried in higher layer signaling, for example, RRC signaling or a medium access control control element (MAC CE).

In this case, both the first apparatus and the third apparatus may receive the first indication information based on the third indication information, to improve the communication efficiency.

In some embodiments, the method provided in FIG. 7 may further include: The second apparatus sends fourth indication information. Accordingly, the first apparatus receives the fourth indication information, and the third apparatus receives the fourth indication information.

The fourth indication information may indicate one or more of the following: a format of the second indication information, a size of the second indication information, a quantity of links corresponding to the second indication information, and whether the second indication information includes configuration information of two time-frequency resources.

The fourth indication information may be carried in higher layer signaling, for example, RRC signaling or a MAC CE.

In this case, both the first apparatus and the third apparatus may receive the first indication information based on the fourth indication information, to improve the communication efficiency.

It may be understood that, in this embodiment of this application, the first indication information and the second indication information may carry a same HARQ process identifier, to indicate that the first information whose transmission is performed on the first resource, the second resource, and the third resource is same data.

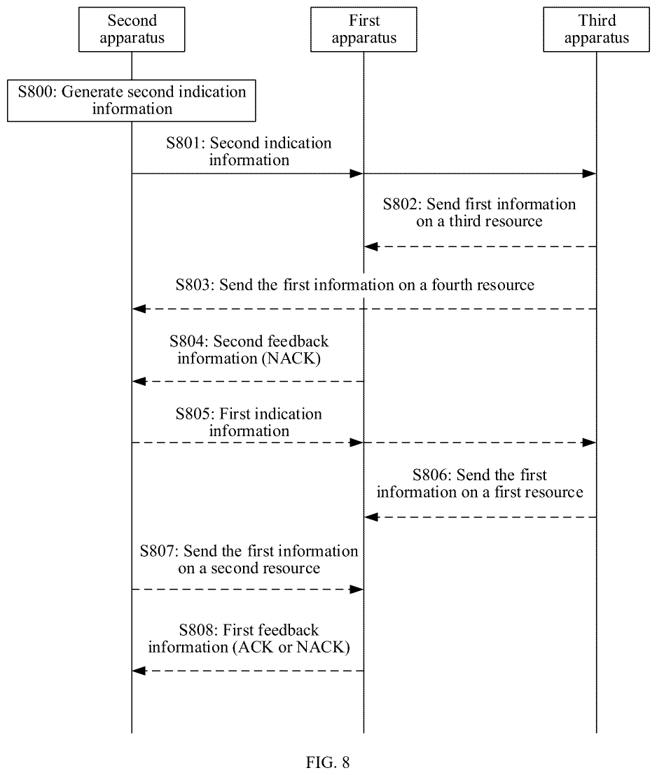

In some possible embodiments, a second apparatus may indicate different transmission paths to a third apparatus, and the third apparatus may send first information through the different paths. The following provides descriptions with reference to FIG. 8. As shown in FIG. 8, a communication method includes the following operations.

S800: A second apparatus generates second indication information.

The second indication information indicates a third resource and a fourth resource.

For embodiments of the second indication information, the third resource, and the fourth resource, refer to the related descriptions in S700-1.

S801: The second apparatus sends the second indication information. Accordingly, a first apparatus receives the second indication information from the second apparatus.

A third apparatus receives the second indication information from the second apparatus.

For an embodiment of S801, refer to the related descriptions in S700-1. Details are not described herein again.

Based on the solution provided in FIG. 8, the second apparatus may indicate, by using the second indication information, resources used by one apparatus to send first information to a plurality of apparatuses, e.g., resources for sending the first information on different links, for example, the third resource for sending the information to the first apparatus and the fourth resource for sending the information to the second apparatus. The third apparatus may send the first information to the different links based on the resources indicated by the second apparatus, to send information on a plurality of links, so that transmissions of the same piece of information on the plurality of links can be implemented, to improve communication reliability. In addition, the information is sent on the plurality of links, and the information may be transmitted in parallel on the different links, so that communication latency can be reduced.

S802: The third apparatus sends the first information on the third resource. Accordingly, the first apparatus receives the first information sent by the third apparatus on the third resource.

For an embodiment of S802, refer to the related descriptions in S700-2. Details are not described herein again.

S803: The third apparatus sends the first information on the fourth resource. Accordingly, the second apparatus receives the first information sent by the third apparatus on the fourth resource.

For an embodiment of S803, refer to the related descriptions in S700-3. Details are not described herein again.

It may be understood that, after receiving the first information sent by the third apparatus on the third resource, the first apparatus may decode the received first information sent by the third apparatus on the third resource. In this case, the method provided in FIG. 8 may further include S804.

A sequence of S802 and S803 is not limited. For example, S802 may be performed before S803, S803 may be performed after S802, or S802 and S803 may be performed in parallel.

S804: The first apparatus sends second feedback information to the second apparatus. Accordingly, the second apparatus may receive the second feedback information.

For an embodiment of the second feedback information, refer to the related descriptions in the communication method provided in FIG. 7. A difference lies in that, in an embodiment, the second feedback information may further indicate that the first apparatus successfully receives the first information. For an embodiment of S804, refer to the related descriptions in the foregoing S700-4. Details are not described herein again.

When the second feedback information indicates that the first information that is sent by the third apparatus on the third resource and that is received by the first apparatus is unsuccessfully decoded, to improve communication reliability, the third apparatus and the second apparatus may further retransmit the first information. In this case, the communication method provided in FIG. 8 may further include S805 to S807.

S805: The second apparatus sends first indication information. Accordingly, the first apparatus receives the first indication information, and the third apparatus receives the first indication information.

The first indication information indicates a first resource and a second resource.

For embodiments of the first indication information, the first resource, and the second resource, refer to the related descriptions in S701. For an embodiment of S805, refer to the related descriptions in S701. Details are not described herein again.

S806: The third apparatus sends the first information on the first resource. Accordingly, the first apparatus receives the first information sent by the third apparatus on the first resource.

For an embodiment of S806, refer to the related descriptions in S702. Details are not described herein again.

S807: The second apparatus sends the first information on the second resource. Accordingly, the first apparatus receives the first information sent by the second apparatus on the second resource.

For an embodiment of S807, refer to the related descriptions in S703. Details are not described herein again.

When the first apparatus receives the first information sent by the third apparatus on the first resource and the first information sent by the second apparatus on the second resource, the method provided in FIG. 8 may further include S808.

A sequence of S806 and S807 is not limited. For example, S806 may be performed before S807, S807 may be performed before S806, or S806 and S807 may be performed in parallel.

S808: The first apparatus sends first feedback information to the second apparatus. Accordingly, the second apparatus receives the first feedback information from the first apparatus.

For an embodiment of S808, refer to the related descriptions in S704. Details are not described herein again.

For technical effects of S803 to S808, refer to the related descriptions in the method provided in FIG. 7. Details are not described herein again.

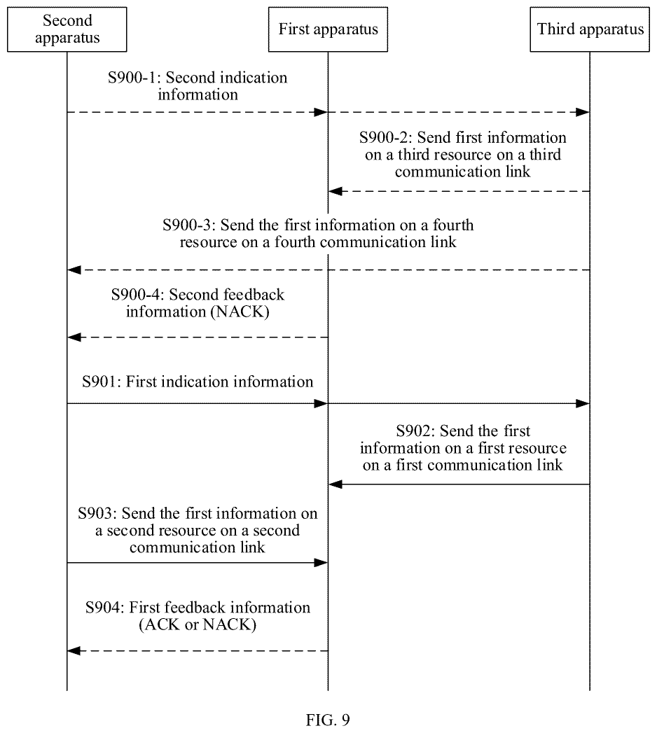

In some possible embodiments, a first apparatus may receive information on different communication links. The following provides descriptions with reference to FIG. 9.

FIG. 9 is a schematic flowchart of another communication method according to an embodiment of this application. As shown in FIG. 9, the communication method includes the following operations.

S901: A second apparatus sends first indication information. Accordingly, a first apparatus receives the first indication information, and a third apparatus receives the first indication information.

The first indication information indicates a first resource on a first communication link and a second resource on a second communication link; and link types of the first communication link and the second communication link are different, or types of transmitting end apparatuses on the first communication link and the second communication link are different.

It may be understood that the first communication link may be different from the second communication link.

For example, the first communication link is a communication link between the first apparatus and the third apparatus. The second communication link is a communication link between the first apparatus and the second apparatus.

For embodiments of the first resource and the second resource, refer to the related descriptions in S701. For an embodiment of S901, refer to the related descriptions in S701. Details are not described herein again.

S902: The third apparatus sends first information on the first resource on the first communication link. Accordingly, the first apparatus receives the first information on the first resource on the first communication link.

For an embodiment of the first information, refer to the related descriptions of the first information in S701. For an embodiment of S902, refer to the related descriptions in S702. Details are not described herein again.

S903: The second apparatus sends the first information on the second resource on the second communication link, and the first apparatus receives the first information on the second resource on the second communication link.

For an embodiment of S903, refer to the related descriptions in S703. Details are not described herein again.

In an embodiment, that the first apparatus receives the first information on the first resource on the first communication link, and receives the first information on the second resource on the second communication link may include: The first apparatus receives the first information on the first resource on the first communication link, and successfully performs decoding; and/or the first apparatus receives the first information on the second resource on the second communication link, and successfully performs decoding; or the first apparatus receives the first information on the first resource on the first communication link, the first apparatus receives the first information on the second resource on the second communication link, and successfully performs combined decoding.

In an embodiment, that the first apparatus receives the first information on the first resource on the first communication link, and receives the first information on the second resource on the second communication link may include: The first apparatus receives the first information on the first resource on the first communication link, and unsuccessfully performs decoding; the first apparatus receives the first information on the second resource on the second communication link, and unsuccessfully performs decoding; and the first apparatus receives the first information on the first resource on the first communication link, the first apparatus receives the first information on the second resource on the second communication link, and combined decoding is unsuccessfully performed. In this case, the first apparatus does not successfully receive the first information.

A sequence of S902 and S903 is not limited. For example, S902 may be performed before S903, S903 may be performed before S902, or S902 and S903 may be performed in parallel.

To feed back a decoding success or unsuccess state of the first information on the first apparatus to another apparatus, for example, the second apparatus, in time to improve communication efficiency, the method provided in FIG. 9 may further include S904.

S904: The first apparatus sends first feedback information. Accordingly, the second apparatus receives the first feedback information.

For an embodiment of the first feedback information, refer to the related descriptions in S704. For an embodiment of S904, refer to the related descriptions in S704. Details are not described herein again.

It may be understood that the foregoing S901 to S903 are performed when the first apparatus does not receive the first information whose transmission is performed on a communication link other than the first communication link and the second communication link. In other words, S901 to S903 may be a procedure of an initial transmission of the first information. Alternatively, the foregoing S901 to S903 may be performed when the first information is unsuccessfully transmitted to the first apparatus on a communication link other than the first communication link and the second communication link. In other words, S901 to S903 are a procedure of a retransmission of the first information.

It is assumed that S901 to S903 are the procedure of the retransmission of the first information. In this case, the communication method provided in FIG. 9 may further include the following operations.

S900-1: The second apparatus sends second indication information. Accordingly, the first apparatus receives the second indication information, and the third apparatus receives the second indication information.

The second indication information indicates a third resource on a third communication link.

The third communication link may be a communication link between the first apparatus and the third apparatus.

For an embodiment of the third resource, refer to the related descriptions in S700-1. For an embodiment of S900-1, refer to the related descriptions in S700-1. Details are not described herein again.

S900-2: The third apparatus sends the first information on the third resource on the third communication link. Accordingly, the first apparatus receives the first information on the third resource on the third communication link.

For an embodiment of S900-2, refer to the related descriptions in S700-2. Details are not described herein again.

In an embodiment, the second indication information further indicates a fourth resource for communication through a fourth communication link; and link types of the third communication link and the fourth communication link are different, or types of transmitting end apparatuses on the third communication link and the fourth communication link are different.

The fourth communication link may be a communication link between the second apparatus and the third apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, that the first apparatus receives the first information on the first resource on the first communication link, and receives the first information on the second resource on the second communication link; and that the first apparatus receives the first information on the third resource on the third communication link include: The first apparatus receives the first information on the first resource on the first communication link, and successfully performs decoding; the first apparatus receives the first information on the second resource on the second communication link, and successfully performs decoding; and/or the first apparatus receives the first information on the third resource on the third communication link, and successfully performs decoding; or the first apparatus receives the first information on the first resource on the first communication link, the first apparatus receives the first information on the second resource on the second communication link, or the first apparatus receives the first information on the third resource on the third communication link; and combined decoding on at least two pieces of the first information is successfully performed.

It may be understood that, in this embodiment of this application, the first information sent by the third apparatus on the first resource on the first communication link, the first information sent by the second apparatus on the second resource on the second communication link, the first information sent by the third apparatus on the third resource on the third communication link, and the first information sent by the third apparatus on the fourth communication link may all be same data, for example, may be a same RV of the same data or different RVs of the same data. For another example, RVs of at least two of the first information sent by the third apparatus on the first resource on the first communication link, the first information sent by the second apparatus on the second resource on the second communication link, the first information sent by the third apparatus on the third resource on the third communication link, and the first information sent by the third apparatus on the fourth communication link are the same.

In addition, the first information that is on the first resource on the first communication link and that is received by the first apparatus is information obtained through a transmission, through a channel, of the first information sent by the third apparatus on the first resource on the first communication link. The first information that is on the first resource on the first communication link and that is received by the first apparatus may be the same as or different from the first information sent by the third apparatus on the first resource on the first communication link.

The first information that is on the second resource on the second communication link and that is received by the first apparatus is information obtained through a transmission, through a channel, of the first information sent by the second apparatus on the second resource on the second communication link. The first information that is on the second resource on the second communication link and that is received by the first apparatus may be the same as or different from the first information sent by the second apparatus on the second resource on the second communication link.

The first information that is on the third resource on the third communication link and that is received by the first apparatus is information obtained through a transmission, through a channel, of the first information sent by the third apparatus on the third resource on the third communication link. The first information that is on the third resource on the third communication link and that is received by the first apparatus may be the same as or different from the first information sent by the third apparatus on the third resource on the third communication link.

The first information that is on the fourth resource on the fourth communication link and that is received by the second apparatus is information obtained through a transmission, through a channel, of the first information sent by the third apparatus on the fourth resource on the fourth communication link. The first information that is on the fourth resource on the fourth communication link and that is received by the second apparatus may be the same as or different from the first information sent by the third apparatus on the fourth resource on the fourth communication link.

S900-3: The third apparatus sends the first information on the fourth resource on the fourth communication link. Accordingly, the second apparatus receives the first information on the fourth resource on the fourth communication link.

A sequence of S900-2 and S900-3 is not limited. For example, S900-2 may be performed before S900-3, S900-3 may be performed after S900-2, or S900-2 and S900-3 may be performed in parallel.

The communication method provided in FIG. 9 may further include S900-4.

S900-4: The first apparatus sends second feedback information. Accordingly, the second apparatus receives the second feedback information.

For an embodiment of the second feedback information, refer to the related descriptions in S700-4. Details are not described herein again.

For example, the first apparatus sends the second feedback information to the second apparatus. Accordingly, the second apparatus receives the second feedback information from the first apparatus.

For an embodiment of S900-4, refer to the related descriptions in S700-4. Details are not described herein again.

In an embodiment, the method provided in FIG. 9 may further include: The second apparatus sends third indication information. Accordingly, the first apparatus receives the third indication information, and the third apparatus receives the third indication information.

The third indication information indicates one or more of the following: a size of the first indication information, a quantity of links corresponding to the first indication information, or a quantity of time-frequency resources indicated by the first indication information.

For an embodiment of sending the third indication information by the second apparatus; and accordingly, receiving the third indication information by the first apparatus, and receiving the third indication information by the third apparatus, refer to the related descriptions in the method provided in FIG. 7.

In an embodiment, the method provided in FIG. 9 may further include: The second apparatus sends fourth indication information. Accordingly, the first apparatus receives the fourth indication information, and the third apparatus receives the fourth indication information.

The fourth indication information indicates one or more of the following: a size of the second indication information, a quantity of links corresponding to the second indication information, or a quantity of time-frequency resources indicated by the second indication information.

For an embodiment of sending the fourth indication information by the second apparatus; and accordingly, receiving the fourth indication information by the first apparatus, and receiving the fourth indication information by the third apparatus, refer to the related descriptions in the method provided in FIG. 7.

For technical effects of the communication method provided in FIG. 9, refer to the technical effects of the communication method provided in FIG. 7. Details are not described herein again.

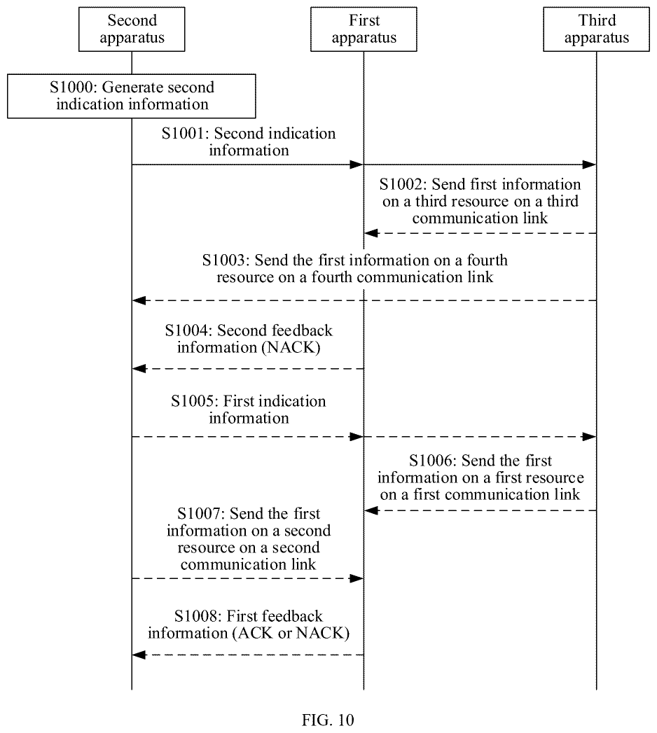

In some possible embodiments, a second apparatus may indicate different transmission paths to a third apparatus, and the third apparatus may send first information through the different paths. The following provides descriptions with reference to FIG. 10. As shown in FIG. 10, a communication method includes the following operations.

S1000: A second apparatus generates second indication information.

For embodiments of the second indication information, a third communication link, a fourth communication link, a third resource, and a fourth resource, refer to the related descriptions in S900-1. Details are not described herein again.

S1001: The second apparatus sends the second indication information. Accordingly, a first apparatus receives the second indication information from the second apparatus.

A third apparatus receives the second indication information from the second apparatus.

The second indication information indicates the third resource on the third communication link and the fourth resource on the fourth communication link.

For an embodiment of S1001, refer to the related descriptions in S900-1. Details are not described herein again.

S1002: The third apparatus sends first information on the third resource on the third communication link. Accordingly, the first apparatus receives the first information on the third resource on the third communication link.

For an embodiment of S1002, refer to the related descriptions in S900-2. Details are not described herein again.

S1003: The third apparatus sends the first information on the fourth resource on the fourth communication link. Accordingly, the second apparatus receives the first information on the fourth resource on the fourth communication link.

For an embodiment of S1003, refer to the related descriptions in S900-3. Details are not described herein again.

A sequence of S1002 and S1003 is not limited. For example, S1002 may be performed before S1003, S1003 may be performed after S1002, or S1002 and S1003 may be performed in parallel.

It may be understood that after receiving the first information on the third resource on the third communication link, the first apparatus may decode the first information. In this case, the method provided in FIG. 10 may further include S1004.

S1004: The first apparatus sends second feedback information to the second apparatus. Accordingly, the second apparatus may receive the second feedback information.

For example, the first apparatus sends the second feedback information to the second apparatus. Accordingly, the second apparatus may receive the second feedback information from the first apparatus.

For an embodiment of the second feedback information, refer to the related descriptions in the communication method provided in FIG. 7. For an embodiment of S1004, refer to the related descriptions in S900-4. Details are not described herein again.

When the second feedback information indicates that the first information that is on the third resource on the fourth communication link and that is received by the first apparatus is unsuccessfully decoded, to improve communication reliability, the third apparatus and the second apparatus may further retransmit the first information. In this case, the communication method provided in FIG. 10 may further include S1005 to S1007.

S1005: The second apparatus sends first indication information. Accordingly, the first apparatus receives the first indication information, and the third apparatus receives the first indication information.

The first indication information indicates a first resource and a second resource.

For embodiments of the first indication information, the first resource, and the second resource, refer to the related descriptions in S901. For an embodiment of S1005, refer to the related descriptions in S901. Details are not described herein again.

S1006: The third apparatus sends the first information on the first resource on a first communication link. Accordingly, the first apparatus receives the first information on the first resource on the first communication link.

For an embodiment of S1006, refer to the related descriptions in S902. Details are not described herein again.

S1007: The second apparatus sends the first information on the second resource on a second communication link. Accordingly, the first apparatus receives the first information on the second resource on the second communication link.

For an embodiment of S1007, refer to the related descriptions in S903. Details are not described herein again.

A sequence of S1006 and S1007 is not limited. For example, S1006 may be performed before S1007, S1007 may be performed before S1006, or S1006 and S1007 may be performed in parallel.

It may be understood that the first apparatus may perform decoding based on results in S1006 and S1007.

To feed back a decoding result of the first information on the first apparatus in time to improve communication efficiency, the method provided in FIG. 10 may further include S1008.

S1008: The first apparatus sends first feedback information to the second apparatus. Accordingly, the second apparatus receives the first feedback information from the first apparatus.

For an embodiment of S1008, refer to the related descriptions in S904. Details are not described herein again.

For technical effects of the communication method provided in FIG. 10, refer to the technical effects of the communication method provided in FIG. 8. Details are not described herein again.

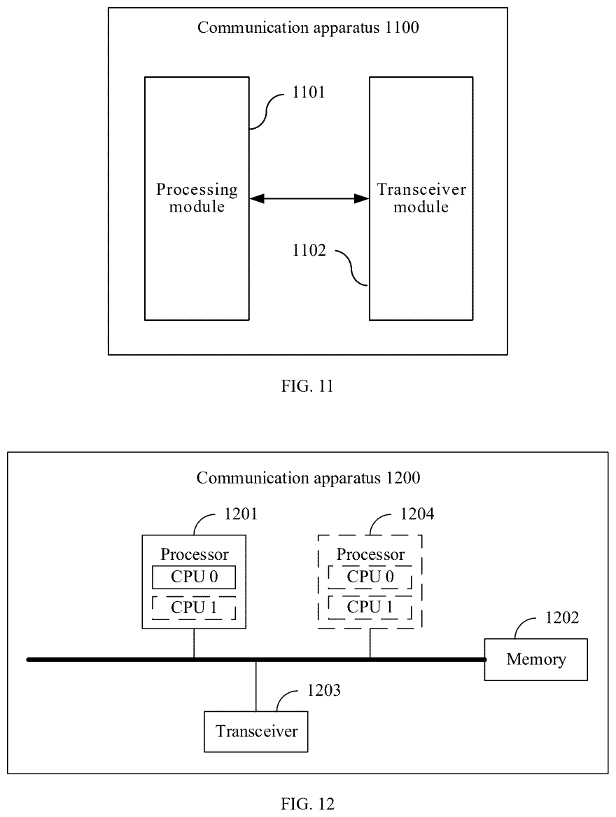

With reference to FIG. 7 to FIG. 10, the foregoing describes in detail the communication methods provided in embodiments of this application. With reference to FIG. 11 and FIG. 12, the following describes in detail communication apparatuses configured to perform the communication methods provided in embodiments of this application.

For example, FIG. 11 is a diagram 1 of a structure of a communication apparatus according to an embodiment of this application. As shown in FIG. 11, the communication apparatus 1100 includes a processing module 1101 and a transceiver module 1102. For ease of description, FIG. 11 shows only main parts of the communication apparatus.

In some embodiments, the communication apparatus 1100 may be used in the communication system shown in FIG. 6, and perform the functions of the first apparatus in the communication method shown in FIG. 7.

The processing module 1101 is configured to receive first indication information from a second apparatus via the transceiver module 1102, where
the first indication information indicates a first resource and a second resource, the first resource is used by a third apparatus to send first information to the communication apparatus 1100, and the second resource is used by the second apparatus to send the first information to the communication apparatus 1100.

The processing module 1101 is further configured to: via the transceiver module 1102, receive the first information sent by the third apparatus on the first resource, and receive the first information sent by the second apparatus on the second resource.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

In this case, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link between the third apparatus and the first apparatus and a second communication link between the second apparatus and the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link.

In an embodiment, that the processing module 1101 is further configured to: via the transceiver module 1102, receive the first information sent by the third apparatus on the first resource, and receive the first information sent by the second apparatus on the second resource may include: The communication apparatus 1100 receives the first information sent by the third apparatus on the first resource, and successfully performs decoding; and/or the communication apparatus 1100 receives the first information sent by the second apparatus on the second resource, and successfully performs decoding; or the processing module 1101 is further configured to: receive, via the transceiver module 1102, the first information sent by the third apparatus on the first resource and the first information sent by the second apparatus on the second resource, and successfully perform combined decoding.

In an embodiment, second indication information further indicates a fourth resource, and the fourth resource is used by the third apparatus to send the first information to the second apparatus.

Further, a third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource may further include a third space domain resource, and the fourth resource may further include a fourth space domain resource. That is, space domain resources may be indicated for different communication links, to perform beam alignment, thereby further improving communication reliability.

In this case, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link between the third apparatus and the first apparatus and a fourth communication link between the third apparatus and the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the first indication information may further include a process number for a transmission of the first information. The second indication information may further include a process number for the transmission of the first information. In this way, the first apparatus can determine, based on the process numbers, whether information on different communication links is a same piece of information.

It may be understood that the process number for the transmission of the first information in the first indication information may be the same as the process number for the transmission of the first information in the second indication information.

In an embodiment, the processing module 1101 is further configured to receive second indication information from the second apparatus via the transceiver module 1102, where the second indication information indicates a third resource, and the third resource is used by the third apparatus to send the first information to the communication apparatus 1100. The processing module 1101 is further configured to receive, via the transceiver module 1102, the first information sent by the third apparatus on the third resource.

In an embodiment, that the processing module 1101 is further configured to: via the transceiver module 1102, receive the first information sent by the third apparatus on the first resource, and receive the first information sent by the second apparatus on the second resource and that the processing module 1101 is further configured to receive, via the transceiver module 1102, the first information sent by the third apparatus on the third resource may include: The communication apparatus 1100 receives the first information sent by the third apparatus on the first resource, and successfully performs decoding; and/or the communication apparatus 1100 receives the first information sent by the second apparatus on the second resource, and successfully performs decoding; or the communication apparatus 1100 receives the first information sent by the third apparatus on the first resource, the communication apparatus 1100 receives the first information sent by the second apparatus on the second resource, or the communication apparatus 1100 receives the first information sent by the third apparatus on the third resource; and combined decoding on at least two pieces of the first information is successfully performed.

In an embodiment, the processing module 1101 is further configured to receive third indication information from the second apparatus via the transceiver module 1102, where the third indication information indicates one or more of the following: a size of the first indication information, a quantity of links corresponding to the first indication information, or a quantity of time-frequency resources indicated by the first indication information.

In an embodiment, the processing module 1101 is further configured to send first feedback information to the second apparatus via the transceiver module 1102, where the first feedback information indicates whether the first apparatus successfully receives the first information.

In an embodiment, the processing module 1101 is further configured to receive fourth indication information from the second apparatus via the transceiver module 1102, where the fourth indication information indicates one or more of the following: a size of the second indication information, a quantity of links corresponding to the second indication information, or a quantity of time-frequency resources indicated by the second indication information.

In an embodiment, the transceiver module 1102 may include a receiving module and a sending module (not shown in FIG. 11). The transceiver module 1102 is configured to implement a sending function and a receiving function of the communication apparatus 1100.

In an embodiment, the communication apparatus 1100 may further include a storage module (not shown in FIG. 11), and the storage module stores a program or instructions. When the processing module 1101 executes the program or the instructions, the communication apparatus 1100 is enabled to perform the functions of the first apparatus in the communication method shown in FIG. 7 or FIG. 9.

It should be understood that the processing module 1101 in the communication apparatus 1100 may be implemented by using a processor or a processor-related circuit component, and may be a processor or a processing unit. The transceiver module 1102 may be implemented by using a transceiver or a transceiver-related circuit component, and may be a transceiver or a transceiver unit.

It should be noted that the communication apparatus 1100 may be a terminal apparatus, a chip (system) or another part or component that may be disposed in the terminal apparatus, or an apparatus including the terminal apparatus. This is not limited in this application.

In addition, for technical effects of the communication apparatus 1100, refer to the technical effects of the communication method shown in FIG. 7. Details are not described herein again.

In some other embodiments, the communication apparatus 1100 may be used in the communication system shown in FIG. 6, and perform the functions of the third apparatus in the communication method shown in FIG. 7.

The processing module 1101 is configured to receive second indication information from a second apparatus via the transceiver module 1102, where
the second indication information indicates a third resource and a fourth resource, the third resource is used by the communication apparatus 1100 to send first information to a first apparatus, and the fourth resource is used by the communication apparatus 1100 to send the first information to the second apparatus.

The processing module 1101 is further configured to: via the transceiver module 1102, send the first information to the first apparatus on the third resource, and send the first information to the second apparatus on the fourth resource.

In an embodiment, the third resource may include a third time-frequency resource, and the fourth resource may include a fourth time-frequency resource.

In an embodiment, the third time-frequency resource may be the same as the fourth time-frequency resource, or the third time-frequency resource may be different from the fourth time-frequency resource.

In an embodiment, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the processing module 1101 is further configured to receive first indication information from the second apparatus via the transceiver module 1102, where the first indication information indicates a first resource, and the first resource is used by the communication apparatus 1100 to send the first information to the first apparatus. The communication apparatus 1100 sends the first information to the first apparatus on the first resource.

In an embodiment, the first indication information may further indicate a second resource, and the second resource is used by the second apparatus to send the first information to the first apparatus.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be the identification information of the third apparatus, and the identification information of the receiving end apparatus on the first communication link may be the identification information of the first apparatus. The identification information of the transmitting end apparatus on the second communication link may be the identification information of the second apparatus, and the identification information of the receiving end apparatus on the second communication link may be the identification information of the first apparatus.

In an embodiment, the first indication information may include a process number for a transmission of the first information. The second indication information may include a process number for the transmission of the first information. In this way, the first apparatus can determine, based on the process numbers, whether information on different communication links is a same piece of information.

It may be understood that the process number for the transmission of the first information in the first indication information may be the same as the process number for the transmission of the first information in the second indication information.

In an embodiment, the processing module 1101 is further configured to receive third indication information from the second apparatus via the transceiver module 1102, where the third indication information indicates one or more of the following: a size of the first indication information, a quantity of links corresponding to the first indication information, or a quantity of time-frequency resources indicated by the first indication information.

In an embodiment, the processing module 1101 is further configured to receive fourth indication information from the second apparatus via the transceiver module 1102, where the fourth indication information indicates one or more of the following: a size of the second indication information, a quantity of links corresponding to the second indication information, or a quantity of time-frequency resources indicated by the second indication information.

In an embodiment, the transceiver module 1102 may include a receiving module and a sending module (not shown in FIG. 11). The transceiver module 1102 is configured to implement a sending function and a receiving function of the communication apparatus 1100.

In an embodiment, the communication apparatus 1100 may further include a storage module (not shown in FIG. 11), and the storage module stores a program or instructions. When the processing module 1101 executes the program or the instructions, the communication apparatus 1100 is enabled to perform the functions of the second apparatus in the communication method shown in FIG. 7.

It should be understood that the processing module 1101 in the communication apparatus 1100 may be implemented by using a processor or a processor-related circuit component, and may be a processor or a processing unit. The transceiver module 1102 may be implemented by using a transceiver or a transceiver-related circuit component, and may be a transceiver or a transceiver unit.

It should be noted that the communication apparatus 1100 may be a terminal apparatus, a chip (system) or another part or component that may be disposed in the terminal apparatus, or an apparatus including the terminal apparatus. This is not limited in this application.

In addition, for technical effects of the communication apparatus 1100, refer to the technical effects of the communication method shown in FIG. 7. Details are not described herein again.

In some other embodiments, the communication apparatus 1100 may be used in the communication system shown in FIG. 6, and perform the functions of the second apparatus in the communication method shown in FIG. 7.

The processing module 1101 is configured to generate first indication information, where the first indication information indicates a first resource and a second resource, the first resource is used by a third apparatus to send first information to a first apparatus, and the second resource is used by the communication apparatus 1100 to send the first information to the first apparatus.

The transceiver module 1102 is configured to send the first indication information.

The processing module 1101 is further configured to send the first information to the first apparatus on the second resource via the transceiver module 1102.

In an embodiment, the first resource may include a first time-frequency resource, and the second resource may include a second time-frequency resource.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may further include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. For example, the identification information of the transmitting end apparatus on the first communication link may be identification information of the third apparatus, and the identification information of the receiving end apparatus on the first communication link may be identification information of the first apparatus. The identification information of the transmitting end apparatus on the second communication link may be identification information of the second apparatus, and the identification information of the receiving end apparatus on the second communication link may be the identification information of the first apparatus.

In an embodiment, the transceiver module 1102 is further configured to send second indication information, where the second indication information indicates a fourth resource, and the fourth resource is used by the third apparatus to send the first information to the communication apparatus 1100. The communication apparatus 1100 receives the first information sent by the third apparatus on the fourth resource.

In an embodiment, the second indication information may further indicate a third resource, and the third resource is used by the third apparatus to send the first information to the first apparatus.

Further, the third resource may include a third time-frequency resource, and the fourth resource may include a fourth time-frequency resource.

The third time-frequency resource may be the same as the fourth time-frequency resource, or the third time-frequency resource may be different from the fourth time-frequency resource.

Further, the third resource further includes a third space domain resource, and the fourth resource further includes a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the transceiver module 1102 is further configured to send third indication information, where the third indication information indicates one or more of the following: a size of the first indication information, a quantity of links corresponding to the first indication information, or a quantity of time-frequency resources indicated by the first indication information.

In an embodiment, the transceiver module 1102 is further configured to receive first feedback information from the first apparatus, where the first feedback information indicates whether the first apparatus successfully receives the first information.

In an embodiment, the transceiver module 1102 is further configured to send fourth indication information, where the fourth indication information indicates one or more of the following: a size of the second indication information, a quantity of links corresponding to the second indication information, or a quantity of time-frequency resources indicated by the second indication information.

In an embodiment, the transceiver module 1102 may include a receiving module and a sending module (not shown in FIG. 11). The transceiver module 1102 is configured to implement a sending function and a receiving function of the communication apparatus 1100.

In an embodiment, the communication apparatus 1100 may further include a storage module (not shown in FIG. 11), and the storage module stores a program or instructions. When the processing module 1101 executes the program or the instructions, the communication apparatus 1100 is enabled to perform the functions of the second apparatus in the communication method shown in FIG. 7.

It should be understood that the processing module 1101 in the communication apparatus 1100 may be implemented by using a processor or a processor-related circuit component, and may be a processor or a processing unit. The transceiver module 1102 may be implemented by using a transceiver or a transceiver-related circuit component, and may be a transceiver or a transceiver unit.

It should be noted that the communication apparatus 1100 may be a network apparatus, a chip (system) or another part or component that may be disposed in the network apparatus, or an apparatus including the network apparatus. This is not limited in this application.

In addition, for technical effects of the communication apparatus 1100, refer to the technical effects of the communication method shown in FIG. 7. Details are not described herein again.

In some other embodiments, the communication apparatus 1100 may be used in the communication system shown in FIG. 6, and perform the functions of the second apparatus in the communication method shown in FIG. 8.

The processing module 1101 is configured to generate second indication information, where
the second indication information indicates a third resource and a fourth resource, the third resource is used by a third apparatus to send first information to a first apparatus, and the fourth resource is used by the third apparatus to send the first information to the second apparatus.

The transceiver module 1102 is configured to send the second indication information.

In an embodiment, the third resource may include a third time-frequency resource, and the fourth resource may include a fourth time-frequency resource.

In an embodiment, the third time-frequency resource may be the same as the fourth time-frequency resource, or the third time-frequency resource may be different from the fourth time-frequency resource.

In an embodiment, the third resource may further include a third space domain resource, and the fourth resource may further include a fourth space domain resource.

For example, the second indication information may include third quasi-colocation relationship information and fourth quasi-colocation relationship information, where the third quasi-colocation relationship information indicates the third space domain resource, and the fourth quasi-colocation relationship information indicates the fourth space domain resource.

In an embodiment, the second indication information further indicates a third communication link from the third apparatus to the first apparatus and a fourth communication link from the third apparatus to the second apparatus.

In an embodiment, the second indication information may include at least one of the following: identification information of a transmitting end apparatus on the third communication link, identification information of a receiving end apparatus on the third communication link, identification information of a transmitting end apparatus on the fourth communication link, and identification information of a receiving end apparatus on the fourth communication link. The identification information of the transmitting end apparatus on the third communication link may be identification information of the third apparatus, and the identification information of the receiving end apparatus on the third communication link may be identification information of the first apparatus. The identification information of the transmitting end apparatus on the fourth communication link may be the identification information of the third apparatus, and the identification information of the receiving end apparatus on the fourth communication link may be identification information of the second apparatus.

In an embodiment, the transceiver module 1102 is further configured to receive the first information sent by the third apparatus on the fourth resource.

In an embodiment, the transceiver module 1102 is further configured to send first indication information, where the first indication information indicates a first resource and a second resource, the first resource is used by the third apparatus to send the first information to the first apparatus, and the second resource is used by the second apparatus to send the first information to the first apparatus. The second apparatus sends the first information to the first apparatus on the second resource.

In an embodiment, the first resource may include a first time-frequency resource, and the second resource may include a second time-frequency resource. In this way, time-frequency resources may be indicated for different communication links.

In an embodiment, the first time-frequency resource may be the same as the second time-frequency resource, or the first time-frequency resource may be different from the second time-frequency resource.

In an embodiment, the first resource may further include a first space domain resource, and the second resource may further include a second space domain resource.

For example, the first indication information may include first quasi-colocation relationship information and second quasi-colocation relationship information, where the first quasi-colocation relationship information indicates the first space domain resource, and the second quasi-colocation relationship information indicates the second space domain resource.

In an embodiment, the first indication information further indicates a first communication link from the third apparatus to the first apparatus and a second communication link from the second apparatus to the first apparatus.

In an embodiment, the first indication information may include at least one of the following: identification information of a transmitting end apparatus on the first communication link, identification information of a receiving end apparatus on the first communication link, identification information of a transmitting end apparatus on the second communication link, and identification information of a receiving end apparatus on the second communication link. The identification information of the transmitting end apparatus on the first communication link may be the identification information of the third apparatus, and the identification information of the receiving end apparatus on the first communication link may be the identification information of the first apparatus. The identification information of the transmitting end apparatus on the second communication link may be the identification information of the second apparatus, and the identification information of the receiving end apparatus on the second communication link may be the identification information of the first apparatus.

In an embodiment, the first indication information may further include a process number for a transmission of the first information. The second indication information may further include a process number for the transmission of the first information.

It may be understood that the process number for the transmission of the first information in the first indication information may be the same as the process number for the transmission of the first information in the second indication information.

In an embodiment, the transceiver module 1102 is further configured to send third indication information, where the third indication information indicates one or more of the following: a size of the first indication information, a quantity of links corresponding to the first indication information, or a quantity of time-frequency resources indicated by the first indication information.

In an embodiment, the transceiver module 1102 is further configured to receive first feedback information from the first apparatus, where the first feedback information indicates whether the first apparatus successfully receives the first information.

In an embodiment, the transceiver module 1102 is further configured to send fourth indication information, where the fourth indication information indicates one or more of the following: a size of the second indication information, a quantity of links corresponding to the second indication information, or a quantity of time-frequency resources indicated by the second indication information.

In an embodiment, the transceiver module 1102 may include a receiving module and a sending module (not shown in FIG. 11). The transceiver module 1102 is configured to implement a sending function and a receiving function of the communication apparatus 1100.

In an embodiment, the communication apparatus 1100 may further include a storage module (not shown in FIG. 11), and the storage module stores a program or instructions. When the processing module 1101 executes the program or the instructions, the communication apparatus 1100 is enabled to perform the functions of the second apparatus in the communication method shown in FIG. 8.

It should be understood that the processing module 1101 in the communication apparatus 1100 may be implemented by using a processor or a processor-related circuit component, and may be a processor or a processing unit. The transceiver module 1102 may be implemented by using a transceiver or a transceiver-related circuit component, and may be a transceiver or a transceiver unit.

It should be noted that the communication apparatus 1100 may be a network apparatus, a chip (system) or another part or component that may be disposed in the network apparatus, or an apparatus including the network apparatus. This is not limited in this application.

In addition, for technical effects of the communication apparatus 1100, refer to the technical effects of the communication method shown in FIG. 8. Details are not described herein again.

For example, FIG. 12 is a diagram 2 of a structure of a communication apparatus according to an embodiment of this application. The communication apparatus may be a terminal device or a network device, or a chip (system) or another part or component that may be disposed in the terminal device or the network device. As shown in FIG. 12, the communication apparatus 1200 may include a processor 1201. In an embodiment, the communication apparatus 1200 may further include a memory 1202 and/or a transceiver 1203. The processor 1201 is coupled to the memory 1202 and the transceiver 1203, for example, may be connected to the memory 1202 and the transceiver 1203 through a communication bus.

The following describes the components of the communication apparatus 1200 with reference to FIG. 12.

The processor 1201 is a control center of the communication apparatus 1200, and may be a processor or a generic term of a plurality of processing elements. For example, the processor 1201 is one or more central processing units (CPUs), may be an application-specific integrated circuit (ASIC), or is configured as one or more integrated circuits implementing embodiments of this application, for example, one or more digital signal processors (DSPs) or one or more field programmable gate arrays (FPGAs).

In an embodiment, the processor 1201 may perform various functions of the communication apparatus 1200 by running or executing a software program stored in the memory 1202 and invoking data stored in the memory 1202.

In an embodiment, in an embodiment, the processor 1201 may include one or more CPUs, for example, a CPU 0 and a CPU 1 shown in FIG. 12.

In an embodiment, the communication apparatus 1200 may also include a plurality of processors, for example, the processor 1201 and a processor 1204 shown in FIG. 12. Each of the processors may be a single-core processor (single-CPU), or may be a multi-core processor (multi-CPU). The processor herein may be one or more devices, circuits, and/or processing cores configured to process data (for example, computer program instructions).

The memory 1202 is configured to store the software program for performing the solutions in this application, and the processor 1201 controls execution. For an embodiment, refer to the foregoing method embodiments. Details are not described herein again.

In an embodiment, the memory 1202 may be a read-only memory (ROM), another type of static storage device that can store static information and instructions, a random access memory (RAM), or another type of dynamic storage device that can store information and instructions, or may be an electrically erasable programmable read-only memory (EEPROM), a compact disc read-only memory (CD-ROM), another compact disc storage, an optical disc storage (including a compact disc, a laser disc, an optical disc, a digital versatile disc, a Blu-ray disc, or the like), a magnetic disk storage medium, another magnetic storage device, or any other medium that can be for carrying or storing expected program code in a form of instructions or a data structure and that is accessible to a computer. However, this is not limited thereto. The memory 1202 may be integrated with the processor 1201, or may exist independently, and is coupled to the processor 1201 through an interface circuit (not shown in FIG. 12) of the communication apparatus 1200. This is not limited in this embodiment of this application.

The transceiver 1203 is configured to communicate with another communication apparatus. For example, the communication apparatus 1200 is the terminal device, and the transceiver 1203 may be configured to communicate with a network device or communicate with another terminal device. For another example, the communication apparatus 1200 is the network device, and the transceiver 1203 may be configured to communicate with a terminal device or communicate with another network device.

In an embodiment, the transceiver 1203 may include a receiver and a transmitter (not separately shown in FIG. 12). The receiver is configured to implement a receiving function, and the transmitter is configured to implement a sending function.

In an embodiment, the transceiver 1203 may be integrated with the processor 1201, or may exist independently, and is coupled to the processor 1201 through the interface circuit (not shown in FIG. 12) of the communication apparatus 1200. This is not limited in this embodiment of this application.

It should be noted that the structure of the communication apparatus 1200 shown in FIG. 12 does not constitute a limitation on the communication apparatus. An actual communication apparatus may include more or fewer parts than those shown in the figure, combine some parts, or have different part arrangements.

In addition, for technical effects of the communication apparatus 1200, refer to the technical effects of the communication methods in the foregoing method embodiments. Details are not described herein again.

It should be understood that, in embodiments of this application, the processor may be a CPU, or the processor may be another general-purpose processor, a DSP, an ASIC, an FPGA, or another programmable logic device, a discrete gate or a transistor logic device, a discrete hardware component, or the like. The general-purpose processor may be a microprocessor, or the processor may be any conventional processor or the like.

It should be further understood that the memory in embodiments of this application may be a volatile memory or a nonvolatile memory, or may include the volatile memory and the nonvolatile memory. The nonvolatile memory may be a ROM, a programmable read-only memory (PROM), an erasable programmable read-only memory (EPROM), an EEPROM, or a flash memory. The volatile memory may be a RAM, and is used as an external cache. By way of example but not limitative description, a plurality of forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus dynamic random access memory (DR RAM).

All or some of the foregoing embodiments may be implemented by using software, hardware (for example, a circuit), firmware, or any other combination. When software is used to implement embodiments, all or some of the foregoing embodiments may be implemented in a form of a computer program product. The computer program product includes one or more computer instructions or computer programs. When the computer instructions or the computer programs are loaded and executed on the computer, the procedure or functions according to embodiments of this application are all or partially generated. The computer may be a general-purpose computer, a special-purpose computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects, and indicates that three relationships may exist. For example, A and/or B may represent the following three cases: Only A exists, both A and B exist, and only B exists, where A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more. “At least one of the following” or a similar expression thereof indicates any combination of the items, and includes a singular item or any combination of plural items. For example, at least one of a, b, or c may indicate: a, b, c, a and b, a and c, b and c, or a, b, and c, where a, b, and c may be singular or plural.

It should be understood that sequence numbers of the foregoing processes do not mean execution sequences in various embodiments of this application. The execution sequences of the processes should be determined according to functions and internal logic of the processes, and should not constitute any limitation on the embodiments of this application.

A person of ordinary skill in the art may be aware that, with reference to the units and algorithm operations in the examples described in embodiments disclosed in this specification, embodiments of this application can be implemented by electronic hardware or a combination of computer software and the electronic hardware. Whether the functions are performed by hardware or software depends on particular applications and design constraint conditions of the technical solutions. A person skilled in the art may use different methods to implement the described functions for each particular application, but it should not be considered that the embodiment goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the foregoing apparatus embodiments are merely examples. For example, division into the units is merely logical function division, and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, that is, may be located at one location, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions in this application essentially, in other words, the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the operations in the methods in embodiments of this application. The foregoing storage medium includes any medium that can store program code, for example, a USB flash drive, a removable hard disk, a ROM, a RAM, a magnetic disk, or an optical disc.

The foregoing descriptions are merely embodiments of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
receiving, by a first apparatus, first indication information from a second apparatus, wherein the first indication information indicates a first resource and a second resource, the first resource is used by a third apparatus to send first information to the first apparatus, and the second resource is used by the second apparatus to send the first information to the first apparatus;
receiving, by the first apparatus, the first information sent by the third apparatus on the first resource, and receiving, by the first apparatus, the first information sent by the second apparatus on the second resource.

2. The communication method according to claim 1, wherein the first resource comprises a first time-frequency resource, and the second resource comprises a second time-frequency resource.

3. The communication method according to claim 2, wherein the first time-frequency resource is same as the second time-frequency resource, or the first time-frequency resource is different from the second time-frequency resource.

4. The communication method according to claim 2, wherein the first resource further comprises a first space domain resource, and the second resource further comprises a second space domain resource.

5. The communication method according to claim 1, wherein receiving, by the first apparatus, the first information sent by the third apparatus on the first resource, and receiving, by the first apparatus, the first information sent by the second apparatus on the second resource comprise:
receiving, by the first apparatus, the first information sent by the third apparatus on the first resource, and successfully performing, by the first apparatus, decoding, and
receiving, by the first apparatus, the first information sent by the second apparatus on the second resource, and successfully performing, by the first apparatus, decoding;
or
receiving, by the first apparatus, the first information sent by the third apparatus on the first resource, receiving, by the first apparatus, the first information sent by the second apparatus on the second resource, and successfully performing, by the first apparatus, combined decoding.

6. The communication method according to claim 1, further comprising:
receiving, by the first apparatus, second indication information from the second apparatus, wherein the second indication information indicates a third resource used by the third apparatus to send the first information to the first apparatus; and
receiving, by the first apparatus, the first information sent by the third apparatus on the third resource.

7. The communication method according to claim 6, wherein
receiving, by the first apparatus, the first information sent by the third apparatus on the first resource, receiving, by the first apparatus, the first information sent by the second apparatus on the second resource, and receiving, by the first apparatus, the first information sent by the third apparatus on the third resource comprise:
receiving, by the first apparatus, the first information sent by the third apparatus on the first resource, and successfully performing, by the first apparatus, decoding,
receiving, by the first apparatus, the first information sent by the second apparatus on the second resource, and successfully performing, by the first apparatus, decoding, and
receiving, by the first apparatus, the first information sent by the third apparatus on the third resource, and successfully performing, by the first apparatus, decoding;
or
receiving, by the first apparatus, the first information sent by the third apparatus on the first resource, receiving, by the first apparatus, the first information sent by the second apparatus on the second resource, or receiving, by the first apparatus, the first information sent by the third apparatus on the third resource; and successfully performing, by the first apparatus, combined decoding on at least two pieces of the first information.

8. The communication method according to claim 1, wherein the first apparatus is a first terminal apparatus, the second apparatus is a network apparatus, and the third apparatus is a second terminal apparatus.

9. A communication method, comprising:
receiving, by a third apparatus, second indication information from a second apparatus, wherein the second indication information indicates a third resource and a fourth resource, the third resource is used by the third apparatus to send first information to a first apparatus, and the fourth resource is used by the third apparatus to send the first information to the second apparatus; and
sending, by the third apparatus, the first information to the first apparatus on the third resource, and sending the first information to the second apparatus on the fourth resource.

10. The communication method according to claim 9, wherein the third resource comprises a third time-frequency resource, and the fourth resource comprises a fourth time-frequency resource.

11. The communication method according to claim 10, wherein the third time-frequency resource is same as the fourth time-frequency resource, or the third time-frequency resource is different from the fourth time-frequency resource.

12. The communication method according to claim 10, wherein the third resource further comprises a third space domain resource, and the fourth resource further comprises a fourth space domain resource.

13. The communication method according to claim 9, further comprising:
receiving, by the third apparatus, first indication information from the second apparatus, wherein the first indication information indicates a first resource used by the third apparatus to send the first information to the first apparatus; and
sending, by the third apparatus, the first information to the first apparatus on the first resource.

14. The communication method according to claim 13, wherein the first indication information further indicates a second resource used by the second apparatus to send the first information to the first apparatus.

15. The communication method according to claim 14, wherein the first resource comprises a first time-frequency resource, and the second resource comprises a second time-frequency resource.

16. The communication method according to claim 15, wherein the first time-frequency resource is same as the second time-frequency resource, or the first time-frequency resource is different from the second time-frequency resource.

17. The communication method according to claim 15, wherein the first resource further comprises a first space domain resource, and the second resource further comprises a second space domain resource.

18. The communication method according to claim 9, wherein the first apparatus is a first terminal apparatus, the second apparatus is a network apparatus, and the third apparatus is a second terminal apparatus.

19. A communication apparatus, comprising:
a transceiver configured to:
receive first indication information from a second apparatus, wherein the first indication information indicates a first resource and a second resource, the first resource is used by a third apparatus to send first information to the communication apparatus, and the second resource is used by the second apparatus to send the first information to the communication apparatus; and
receive the first information sent by the third apparatus on the first resource, and receive the first information sent by the second apparatus on the second resource.

20. The communication apparatus according to claim 19, wherein the first resource comprises a first time-frequency resource, and the second resource comprises a second time-frequency resource.
